(19) United States
(12) Patent Application Publication
(10) Pub. No.: US 2010/0129286 A1
(43) Pub. Date: May 27, 2010

(54) Methods of controlling the morphology of perovskite submicron-sized particles

(75) Inventors: Stanislaus S. Wong, Stony Brook, NY (US); Hongjun Zhou, Austin, TX (US)

Correspondence Address: HOFFMANN & BARON, LLP, 6900 JERICHO TURNPIKE, SYOSSET, NY, 11791, US

(73) Assignee: The Research Foundation of the State University of New York

(21) Appl. No.: 12/587,491

(22) Filed: Oct. 6, 2009

Related U.S. Application Data
(60) Provisional application No. 61/195,622, filed on Oct. 6, 2008.

(51) Int. Cl. C01G 25/02

(52) U.S. Cl. 423/594.12

(57) ABSTRACT

The present invention includes a method of making a plurality of nanoparticles comprising single crystalline spherical BaZrO₃ particles, cubic BaZrO₃ particles or a mixture of both. The method comprises: providing a mixture of a barium precursor, a zirconium precursor and a hydroxide salt or hydroxide salts; heating the mixture to an isothermic annealing temperature, wherein the annealing temperature is in a range of from about 470° C. to about 800° C.; annealing the mixture at the isothermic annealing temperature for an annealing time of in a range of about 15 minutes to about 280 minutes; and cooling the mixture at a fixed cooling rate to form the plurality of nanoparticles, wherein the cooling rate is in a range of from about 2° C./minute to about 200° C./minute. The ratio of spherical particles to cubic particles in the plurality is greater if the isothermic annealing temperature is at the higher end of the range; the ratio of spherical particles to cubic particles in the plurality is greater if the annealing time is at the higher end of the range; and the ratio of spherical particles to cubic particles in the plurality is greater if the cooling rate is at the lower end of the range.

This invention was made with government support under grant numbers DMII-0403859 and CAREER award DMR-0348239 awarded by the National Science Foundation., and DE-AC02-98CH10886 awarded by the US Department of Energy. The government has certain rights in the invention.

### CROSS-REFERENCE TO RELATED APPLICATION

This application claims the benefit of U.S. Provisional Application No. 61/195,622, filed Oct. 6, 2008, which is incorporated herein by reference in its entirety.

### BACKGROUND OF THE INVENTION

The synthesis of complex ternary transition metal oxides, many of which possess a perovskite structure, is a major focal point of interest because a majority of these materials possesses a host of interesting physical properties with applications in fields ranging from ferroelectricity, ferromagnetism, piezoelectricity, pyroelectricity, high-temperature superconductivity to optoelectronics. (Zhang, et al. J. Appl. Phys., 2004, 95, 4291; Burscu, E.; Ravichandran, et al. J. Mech. Phys. Solids, 2004, 52, 823; Zook, J. D. et al. Phys. Rev. Lett., 1966, 17, 960.) Dr. Stanislaus Wong's group has expended significant effort in demonstrating that the molten salt synthesis (MSS) method, in particular, is one of the simplest, most versatile, and highly cost-effective approaches available for obtaining crystalline, chemically pure, single-phase nanoscale materials at lower temperatures and often in overall shorter reaction times with little residual impurities as compared with conventional solid-state reactions. (Hayashi et al. J. Mater. Sci., 1986, 21, 757.) The intrinsic scalability, flexibility, and facility of this technique render it attractive for the fabrication of a range of ternary metal oxides.

The fundamental basis of molten salt reactions is the reliance on the use of inorganic molten salt as the reaction medium. Salt media used by other groups have ranged from the eutectic mixture of AlCl₃/NaCl/KCl with a relatively low melting point of 89° C. to cryolite or Na₃AlF₆ with a particularly high melting point of 1003° C. Moreover, these salts often possess a host of favorable physicochemical properties such as greater oxidizing potential, higher mass transfer, higher thermal conductivity, as well as relatively lower viscosities and densities, as compared with conventional solvents. (Volkov, S. V. Chem. Soc. Rev., 1990, 19, 21.) In fact, with MSS, (i) the identity as well as the size of the anion associated with the salt, (ii) the nature of the solubility values as well as dissolution rates of the constituent components within the molten salt itself, (iii) the precise melting point of either the salt or complex salt mixture used, (iv) heating temperature and duration, as well as (v) the unique morphological (e.g., shape) and chemical composition of the precursors involved are all important, readily controllable factors that influence the growth rate as well as the resultant structural characteristics (i.e., size, shape, and crystallinity) of the as-prepared particles. (Hayashi et al. J. Mater. Sci., 1986; 21, 757; Volkov, S. V. Chem. Soc. Rev., 1990; 19, 21; Zboril et al. Chem. Mater.; 2002, 14, 969; Yoon et al. J. Mater. Sci., 1998, 33, 2977; Bloom, H. The Chemistry of Molten Salts; W. A. Benjamin, Inc., New York, 1967.)

Dr. Stanislaus Wong's group has previously investigated reliable synthesis and characterization of morphological motifs of BaTiO₃, SrTiO₃, and Ca₁₋ₓSrTiO₃ nanostructures. (Mao et al. J. Am. Chem. Soc., 2003, 125, 15718; Mao et al. Adv. Mater., 2005, 17, 2194.)

Barium zirconate (BaZrO₃) is a cubic perovskite with a unit cell edge length of 4.19 Å. BaZrO₃ exhibits high protonic conductivity upon the addition of dopants, rendering it suitable for applications ranging from fuel cells to hydrogen sensors operated at high temperature. (Yajima et al. Solid State Ionics, 1992, 51, 101.) Its high dielectric constant (30-40), its wide band-gap (˜5.3 eV), and its correspondingly high breakdown strength make this oxide material appropriate for usage in high voltage and high reliability capacitive applications, such as electro-optic devices and multilayer capacitors. (Shende et al. J. Am. Ceram. Soc., 2001, 84, 1648; Macmanus-Driscoll et al. Nat. Mater., 2004, 3, 439; Koenig et al. J. Am. Ceram. Soc., 1964, 47, 87.) Moreover, its high melting point (2600° C.) and its chemical stability at high temperatures render it suitable not only as a refractory material but also as a precursor in the production of high-quality, high T_{c} superconducting materials. (Kang et al. Supercond. Sci. Tech., 2007, 20, 11.) Finally, its sensitivity to humidity is useful for its application as a moisture sensor. (Viviani et al. J. Euro. Ceram. Soc., 2001, 21, 1981.)

There are a number of existing methods used to synthesize barium zirconate. Apart from freeze-drying (Badica et al. Mater. Lett., 2003, 58, 250), many reported studies have relied on liquid-phase reactions such as sol-gel (Ling et al. Mater. Chem. Phys., 2002, 75, 170; Sin et al. J. Am. Ceram. Soc., 2002, 85, 1928), co-precipitation, (Brzezinska-Miecznik et al. Mater. Lett., 2002, 56, 273), thermal decomposition (Kirby et al. J. Mater. Sci., 2005, 40, 97), and hydrothermal techniques (Lencka et al. Chem. Mater., 1997, 9, 1116; Lu et al. J. Cryst. Growth, 2004, 266, 539; Kutty et al. J. Mater. Sci., 1990, 25, 3649; Vivekanadan et al. Mater. Res. Bull., 1987, 22, 99; Millot et al. J. Eur. Ceram. Soc., 2005, 25, 2013; Kolen'ko et al. Inorg. Mater., 2002, 38, 320), as well as conventional solid state reactions (Azad et al. Mater. Res. Bull., 2002, 37, 85; Yamanaka et al. J. Alloys Compnds., 2003, 359, 1.), in addition to combinations thereof.

Many of these reactions often involved either an additional sintering step (Robertz et al. Intl. J. Inorg. Mater., 2001, 3, 1185) or sonication step (e.g., nanoparticle formation probed as a function of ultrasonicator output power and time (Athawale et al. J. Metast. Nanocryst. Mater., 2005, 23, 3)).

Barium zirconate particles can also be formed by the reaction of very fine (70-90 nm) ZrO₂ powders, and coarse (−1 micron) BaCO₃ powders in both dry as well as humid air using a temperature range of 900 to 1300° C. (Ubaldini et al. J. Am. Ceram. Soc., 2003, 86, 19.) Recently, the synthesis of nanoscale barium zirconate was initiated by urea-induced precipitation followed by a low temperature thermal treatment (Boschini et al. J. Europ. Ceram. Soc., 2003, 23, 3035). A reported solvothermal method relied on the dissolution of either alkali or alkaline earth metals (e.g., Ba) in benzyl alcohol and subsequent reaction with transition metal alkoxides (e.g., Zr(OiPr)₄.HOiPr) at low temperature ranges from 200 to 220° C. for 3 days. (Niederberger et al. Angew. Chem. Intl. Ed., 2004, 43, 2270.) A typical hydrothermal analogue to this reaction is associated with the reaction of ZrOCl₂.8H₂O, Ba(OH)₂, and KOH to create a slurry (pH 13), which was then heated in an autoclave at 130° C. for 1 day. (Lencka et al. Chem. Mater., 1997, 9, 1116; Lu et al. J. Cryst. Growth, 2004, 266, 539; Kutty et al. J. Mater. Sci., 1990, 25, 3649; Vivekanadan et al. Mater. Res. Bull., 1987, 22, 99; Millot et al. J. Eur. Ceram. Soc., 2005, 25, 2013; Kolen'ko et al. Inorg. Mater., 2002, 38, 320.)

In addition, barium zirconate nanoparticles have been prepared by a reverse micelle process in which (a) barium nitrate and zirconium dinitrate oxide were used as precursor materials, (b) sodium hydroxide was utilized as the precipitating agent, and (c) n-octane, 1-butanol, and cetyl trimethylammonium bromide were dispersed together to form the desired microemulsion. (Leonard et al. Chem. Mater., 2005, 17, 4010.) Lastly, a microwave-assisted preparation, run under ambient conditions, has been reported in which BaCl₂.hydrate was initially dissolved in ethylene glycol, reacted with KOH, and ultimately microwave refluxed in the presence of ZrOCl₂ for 2 h, all under a static pressure of N₂, to generate particles measuring ˜200 by 600 nm. (Palchik et al. J. Mater. Chem., 2000, 10, 1251.)

Although solid solutions of BaZrO₃—SrZrO₃ were formed using the molten salt eutectic of NaOH—KOH as a solvent, the synthesis of either nanoscale or micron-sized pristine BaZrO₃ particles using this particular eutectic solvent has not been reported (Gopalan et al. J. Mater. Res., 1996, 11, 1863). One of the few manuscripts to deal with shape control in BaZrO₃ utilized a hydrothermal method under very high pH conditions to generate truncated rhombic dodecahedra and spheres with dimensions over 1 μm; shape control was achieved therein by changing solvent polarity (Lu et al. J. Cryst. Growth, 2004, 266, 539). Additionally, there have been several studies dealing with shape control in liquid-phase reactions, not molten salt synthesis (Wiley et al. Chem. Eur. J., 2005, 11, 454; Pileni, M.-P. Nat. Mater., 2003, 2, 145).

Dr. Stanislaus Wong's group has recently preliminarily investigated the narrow issue of controlling the percentage of cubes versus spheres in samples of barium zirconate generated by molten salt synthesis (Zhou et al. J. Mater. Chem., 2007, 17, 1707). However, a systematic method by which to address the broader and more generalized problem of parameter selection in the molten salt method has not been provided (Wang et al. Mater. Sci. Engin. B, 2006, 130, 277; Ito et al. J. Am. Ceram. Soc., 1995, 78, 2695; Battisha et al. Mater. Lett., 2002, 57, 183). In particular, there has not been an efficient method by which to synthesize submicron-sized perovskite particles using molten salt synthesis with reliable, reproducible size, shape, and composition control.

### SUMMARY OF THE INVENTION

In one embodiment, the present invention is a method of making a plurality of nanoparticles comprising single crystalline spherical BaZrO₃ particles, cubic BaZrO₃ particles or a mixture of both. The method comprises: (a) providing a mixture of a barium precursor, a zirconium precursor and a hydroxide salt or hydroxide salts; (b) heating the mixture to an isothermic annealing temperature, wherein the annealing temperature is in a range of from about 470° C. to about 800° C.; (c) annealing the mixture at the isothermic annealing temperature for an annealing time of in a range of about 15 minutes to about 280 minutes; and (d) cooling the mixture at a fixed cooling rate to form the plurality of nanoparticles, wherein the cooling rate is in a range of from about 2° C./minute to about 200° C./minute. The ratio of spherical particles to cubic particles in the plurality is greater if the isothermic annealing temperature is at the higher end of the range; the ratio of spherical particles to cubic particles in the plurality is greater if the annealing time is at the higher end of the range; and the ratio of spherical particles to cubic particles in the plurality is greater if the cooling rate is at the lower end of the range.

When the isothermic annealing temperature is in a range of about 500° C. to about 540° C.; the annealing time is in a range of about 240 minutes to about 260 minutes; and the fixed cooling rate is in a range of about 90° C./minute to about 110° C./minute, then the method yields a plurality comprising about 50% single crystalline spherical BaZrO₃ particles, and about 50% cubic BaZrO₃ particles. The spherical BaZrO₃ particles have a diameter of about 400 nm to about 450 nm, and cubic BaZrO₃ particles have an edge length of about 400 nm to about 450 nm.

When the isothermic annealing temperature is in a range of about 570° C. to about 670° C.; the annealing time is in a range of about 220 minutes to about 240 minutes; and the fixed cooling rate is in a range of about 90° C./minute to about 110° C./minute, the method yields a plurality comprising about 65% single crystalline spherical BaZrO₃ particles, and about 35% cubic BaZrO₃ particles. The spherical BaZrO₃ particles have a diameter of about 320 nm to about 400 nm, and the cubic BaZrO₃ particles have an edge length of about 320 nm to about 400 nm.

When the isothermic annealing temperature is in a range of about 700° C. to about 740° C.; the annealing time is in a range of about 180 minutes to about 210 minutes; and the fixed cooling rate is in a range of about 90° C./minute to about 110° C./minute, the method yields a plurality comprising about 95% single crystalline spherical BaZrO₃ particles, and about 5% cubic BaZrO₃ particles. The spherical BaZrO₃ particles have a diameter of about 290 nm to about 310 nm, and the cubic BaZrO₃ particles have an edge length of about 290 nm to about 320 nm.

When the isothermic annealing temperature is in a range of about 670° C. to about 620° C.; the annealing time is in a range of about 10 minutes to about 40 minutes; and the fixed cooling rate is in a range of about 90° C./minute to about 110° C./minute, the method yields a plurality comprising about 100% cubic BaZrO₃ particles. The cubic BaZrO₃ particles have an edge length of about 100 nm to about 140 nm.

When the isothermic annealing temperature is about 700° C. to about 740° C.; the annealing time is in a range of about 40 minutes to about 90 minutes; and the fixed cooling rate is in a range of about 90° C./minute to about 110° C./minute, the method yields a plurality comprising about 20% single crystalline spherical BaZrO₃ particles, and about 80% cubic BaZrO₃ particles. The spherical BaZrO₃ particles have a diameter of about 145 nm to about 200 nm, and the cubic BaZrO₃ particles have an edge length of about 145 nm to about 200 nm.

Where the isothermic annealing temperature is in a range of about 700° C. to about 740° C.; the annealing time is in a range of about 100 minutes to about 140 minutes; and the fixed cooling rate is in a range of about 90° C./minute to about 110° C./minute, the method yields a plurality comprising about 70% single crystalline spherical BaZrO₃ particles, and about 30% cubic BaZrO₃ particles. The spherical BaZrO₃ particles have a diameter of about 200 nm to about 285 nm, and the cubic BaZrO₃ particles have an edge length of about 200 nm to about 285 nm.

Where the isothermic annealing temperature is in a range of about 500° C. to about 540° C.; the annealing time is in a range of about 50 minutes to about 90 minutes; and the fixed cooling rate is in a range of about 90° C./minute to about 110° C./minute, the method yields a plurality comprising about 10% single crystalline spherical BaZrO₃ particles, and about 90% cubic BaZrO₃ particles. The spherical BaZrO₃ particles have a diameter of about 200 nm to about 218 nm, and the cubic BaZrO₃ particles have an edge length of about 200 nm to about 218 nm.

When the isothermic annealing temperature is in a range of about 500° C. to about 540° C.; the annealing time is in a range of about 90 minutes to about 120 minutes; and the fixed cooling rate is in a range of about 90° C./minute to about 110° C./minute, the method yields a plurality comprising about 15% single crystalline spherical BaZrO₃ particles, and about 85% cubic BaZrO₃ particles. The spherical BaZrO₃ particles have a diameter of about 218 nm to about 250 nm, and the cubic BaZrO₃ particles have an edge length of about 218 nm to about 250 nm.

When the isothermic annealing temperature is in a range of about 500° C. to about 540° C.; the annealing time is in a range of about 160 minutes to about 190 minutes; and the fixed cooling rate is in a range of about 90° C./minute to about 110° C./minute, the method yields a plurality comprising about 25% single crystalline spherical BaZrO₃ particles, and about 75% cubic BaZrO₃ particles. The spherical BaZrO₃ particles have a diameter of about 270 nm to about 330 nm, and the cubic BaZrO₃ particles have an edge length of about 280 nm to about 310 nm.

When the isothermic annealing temperature is in a range of about 500° C. to about 540° C.; the annealing time is in a range of about 220 minutes to about 280 minutes; and the fixed cooling rate is in a range of about 2° C./minute to about 20° C./minute, the method yields a plurality comprising about 60% single crystalline spherical BaZrO₃ particles, and about 40% cubic BaZrO₃ particles. The spherical BaZrO₃ particles have a diameter of about 440 nm to about 460 nm, and the cubic BaZrO₃ particles have an edge length of about 440 nm to about 460 nm.

When the isothermic annealing temperature is in a range of about 700° C. to about 740° C.; the annealing time is in a range of about 10 minutes to about 40 minutes; and the fixed cooling rate is in a range of about 2° C./minute to about 20° C./minute, the method yields a plurality comprising about 50% single crystalline spherical BaZrO₃ particles, and about 50% cubic BaZrO₃ particles. The spherical BaZrO₃ particles have a diameter of about 180 nm to about 220 nm, and the cubic BaZrO₃ particles have an edge length of about 180 nm to about 220 nm.

Wherein the isothermic annealing temperature is in a range of about 700° C. to about 740° C.; the annealing time is in a range of about 110 minutes to about 130 minutes; and the fixed cooling rate is in a range of about 2° C./minute to about 20° C./minute, the method yields a plurality comprising about 100% single crystalline spherical BaZrO₃ particles. The spherical BaZrO₃ particles have a diameter of about 290 nm to about 310 nm.

In another embodiment, the present invention is a method of making a plurality of single crystalline spherical BaZrO₃ particles. The method comprises: (a) providing a mixture of a barium precursor, a zirconium precursor and a hydroxide salt or hydroxide salts; (b) heating the mixture to an isothermic annealing temperature, wherein the annealing temperature is in a range of from about 700° C. to about 800° C.; (c) annealing the mixture at the isothermic annealing temperature for an annealing time of in a range of about 100 minutes to about 280 minutes; and (d) cooling the mixture at a fixed cooling rate to form a plurality of single crystalline spherical BaZrO₃ particles, wherein the cooling rate is in a range of from about 2° C./minute to about 20° C./minute. The size of the spherical particles is larger when the isothermic annealing temperature is at the higher end of the range; the size of spherical particles is larger when the annealing time is at the higher end of the range; and the size of the spherical particles is larger when the cooling rate is in the lower end of the range.

In one embodiment, the barium precursor is barium oxalate, and the spherical BaZrO₃ particles have a diameter of about 310 nm to about 330 nm. In one embodiment, the barium precursor is barium oxide, and the spherical BaZrO₃ particles have a diameter of about 480 nm to about 500 nm. In one embodiment, the barium precursor is barium carbonate, and the spherical BaZrO₃ particles have a diameter of about 330 nm to about 350 nm. In one embodiment, the barium precursor is barium acetate, and the spherical BaZrO₃ particles have a diameter of about 290 nm to about 310 nm.

In another embodiment, the present invention is a method of making a plurality of single crystalline cubic BaZrO₃ particles. The method comprises: (a) providing a mixture of a barium precursor, a zirconium precursor and a chloride salt or chloride salts; (b) heating the mixture to an isothermic annealing temperature, wherein the annealing temperature is in a range of from about 500° C. to about 900° C.; (c) annealing the mixture at the isothermic annealing temperature for an annealing time in a range of about 15 minutes to about 250 minutes; (d) cooling the mixture at a fixed cooling rate to form a plurality of single crystalline cubic BaZrO₃ particles, wherein the cooling rate is in a range of from about 2° C./minute to about 200° C./minute. The size of the cubic particles is larger when the isothermic annealing temperature is at the higher end of the range; the size of the cubic particles is larger when the annealing time is greater; and the size of the cubic articles is larger when the cooling rate is at the lower end of the range.

In another embodiment, the present invention is a method of controlling the morphology of a plurality of produced nanoparticles. The method comprises: (a) providing a mixture of a barium precursor, a zirconium precursor and salt; (b) heating the mixture to an isothermic annealing temperature, wherein the annealing temperature is in a range of from about 500° C. to about 900° C., or 600° C. to about 800° C.; (c) annealing the mixture at the isothermic annealing temperature for an annealing time in a range of about 15 minutes to about 280 minutes; and (d) cooling the mixture at a fixed cooling rate to produce a plurality of nanoparticles, wherein the cooling rate is in a range of from about 2° C./minute to about 200° C./minute. The ratio of spherical particles to cubic particles in the plurality is greater if the salt is a hydroxide salt; the plurality consists essentially of cubic particles if the salt is a halogenated salt; the ratio of spherical particles to cubic particles in the plurality is greater if the isothermic annealing temperature is at the higher end of the range; the ratio of spherical particles to cubic particles in the plurality is greater if the annealing time is at the higher end of the range; and the ratio of spherical particles to cubic particles in the plurality is greater if the cooling rate is at the lower end of the range. Preferably, the halogenated salt is a chloride salt.

In one embodiment, the mixtures in the aforementioned methods do not include a surfactant. In one embodiment, the mixtures in these methods do not include a nitric salt.

In one embodiment, the barium precursor in the aforementioned methods is barium oxalate, barium oxide, barium carbonate, barium acetate, or mixtures thereof. In one embodiment, the zirconium precursor in these methods is ZrO₂. In one embodiment, the hydroxide salt or hydroxide salts in these methods is sodium hydroxide, potassium hydroxide or sodium hydroxide/potassium hydroxide.

In one embodiment, in the aforementioned methods, the ratio of the barium precursor:zirconium precursor:hydroxide salt or hydroxide salts is about 1:1:1 to about 1:1:100. In one embodiment, the ratio of the barium precursor:zirconium precursor:hydroxide salt or hydroxide salts is about 1:1:20.

The present invention overcomes the shortcomings in the prior art by providing methods of isolating and analyzing the individual roles of salt medium, annealing temperatures, cooling rates, as well as the precursors used in determining overall product morphology, composition, size, and shape in a molten salt synthesis of crystalline submicron-sized perovskite particles.

The inventions provide a high degree of tunability with respect to parameter selection for molten salt chemical reactions allowing production of large amounts of purified products with predictable, reproducible morphology, in particular, for the production of ternary metal oxide perovskite structures with reliable shape and size control.

### BRIEF DESCRIPTION OF THE DRAWINGS

FIG. 1. SEM images of as-prepared BaZrO₃ (a) cubes and (b) spheres; (c) and (d): XRD and EDS patterns of these samples, respectively. The lower pattern in (c) corresponds to a database standard (JCPDS 06-0399) for the cubic phase of barium zirconate. In (d), the carbon peak originates from the conductive carbon tape. In (e) and (f), TEM, HRTEM and SAED pattern (inset) of a BaZrO₃ cube. In (g) and (h), TEM, HRTEM and SAED pattern (inset) of a BaZrO₃ sphere.

FIG. 2. Selection of Salt. (a) XRD patterns of samples A to D from Table 1, prepared using a molten medium containing no salt, NaOH/KOH, NaCl/KCl, and NaCl, respectively. ( [symbol] , ▴ and represent refection peaks associated with BaZrO₃, BaCO₃ and ZrO₂ respectively.) (b-e) are associated SEM images of samples A to D respectively.

FIG. 3. Annealing Temperature. (a) XRD patterns of samples G, H and I from Table 1. ( [symbol] , ▴ and represent BaZrO₃, BaCO₃, and ZrO₂ respectively.) (b) to (d) are associated SEM images of samples G, H and I, respectively (i.e., in order of increasing annealing temperatures from 520 to 720° C.). Scale bar=1 μm.

FIG. 4. Impact of overall reaction time. Annealing performed at 720° C. (a) to (d) are SEM images of samples J, K, L and I, described in Table 1 (i.e., in order of increasing overall reaction times from 170 to 350 min.). (e) are corresponding XRD patterns of samples J, K, L and I. Scale bar=1 μm.

FIG. 5. Influence of Cooling Rates. SEM images of samples (a) Q and (b) J respectively. (c) are corresponding XRD patterns of samples Q and J, cooled at 3.5 and 100° C./min, respectively.

FIG. 6. Choice of Precursors. (a) to (g) are SEM images of samples B and of S to X, respectively, prepared using a range of barium and zirconium precursors. (h) are the corresponding XRD patterns of these samples. Scale bar in microscopy images=1 μm. ( [symbol] , ▴ and represent reflection peaks associated with BaZrO₃, BaCO₃, and ZrO₂, respectively.)

FIG. 7. Time-dependent particle evolution. (a) and (b) are Furnace temperature, Weight percentage of BaZrO₃, Average particle size, and Percentage of spheres of samples 1 to 11 plotted as a function of overall reaction time at a constant heating rate of 5 C.°/min. Lines connecting data points are intended for visual guidance only. (c) are the corresponding XRD patterns of samples 1 to 11 upon mixing with a constant amount of ZrSiO₄ used as an internal standard. ( [symbol] , ▴, and ▪ represent BaZrO₃, BaCO₃, ZrO₂, and ZrSiO₄ respectively.)

FIG. 8. Time-dependent particle evolution. (a) to (f) are SEM images of samples 1, 3, 5, 7, 9, and 11, respectively. Scale bar=1 μm.

### DETAILED DESCRIPTION OF THE INVENTION

The present invention relates to nanostructures, in particular to perovskite nanostructures, and methods of making same.

Perovskites have the formula ABO₃. Examples of perovskites include alkaline earth metal zirconates, such as BaZrO₃; alkaline earth metal titanates, such as BaTiO₃, SrTiO₃, and CaTiO₃; and BaNbO₃, CaNbO₃, SrNbO₃, BaMoO₃, CaMoO₃, SrMoO₃, BaVO₃, CaVO₃, SrVO₃, BaSnO₃, CaSnO₃, and SrSnO₃.

In one embodiment, the invention includes a method of making a plurality of nanoparticles comprising single crystalline spherical particles, cubic particles or a mixture of both. In another embodiment, the invention includes a method of making a plurality of nanoparticles consisting essentially of (or consisting of) single crystalline spherical particles, cubic particles or a mixture of both. That is, other components that may materially affect the basic and novel characteristics of the single crystalline spherical particles, cubic particles, or a mixture of both are specifically excluded from the plurality.

These methods enable the components of the resulting plurality to be predictable with regard to the ratio of the spherical particles to the cubic particles. The method also enables the average size of the spherical particles and/or the cubic particles in a plurality to be controlled. The control is achieved by varying experimental parameters.

The method comprises providing a mixture of precursors and hydroxide salt. Below is a list of precursors used to make each type of perovskite.

| Perovskite ABO₃ | Precursor 1 | Precursor 2 |
|---|---|---|
| BaZrO₃ | Barium oxalate, oxide, | ZrO₂ |
| | carbonate, acetate | |
| CaTiO₃ | Calcium oxalate, oxide, | TiO₂ |
| | carbonate, acetate | |
| BaTiO₃ | Barium oxalate, oxide, | TiO₂ |
| | carbonate, acetate | |
| SrTiO₃ | oxalate, oxide, carbonate, | TiO₂ |
| | acetate | |
| BaNbO₃(Ca, Sr) | oxalate, oxide, carbonate, | NbO₂ |
| | acetate | |
| BaMoO₃(Ca, Sr) | oxalate, oxide, carbonate, | MoO₂ |
| | acetate | |
| BaVO₃(Ca, Sr) | oxalate, oxide, carbonate, | VO₂ |
| | acetate | |
| BaSnO₃(Ca, Sr) | oxalate, oxide, carbonate, | SnO₂ |
| | acetate | |

Precursor 1 can be made up of only oxalate, only oxide, only carbonate, or only acetate; or can be any mix of oxalate, oxide, carbonate and acetate. The ratio between Precursor 1 and Precursor 2 is approximately 1:1.

The “hydroxide salt” is sodium hydroxide, potassium hydroxide or sodium hydroxide/potassium hydroxide. Preferably a eutectic mixture of salt is used.

The ratio of “precursor 1”:“precursor 2”:hydroxide salt is about 1:1:1 to about 1:1:100. Preferably, the ratio of “precursor 1”:“precursor 2”:hydroxide salt is about 1:1:20, 1:1:30, or 1:1:40. For example, the ratio of the barium precursor:zirconium precursor:hydroxide salt is about 1:1:20.

The mixture of precursors and hydroxide salt is heated to an isothermic annealing temperature, wherein the annealing temperature is in a range from about 470° C. to about 850° C. The mixture is annealed at the isothermic annealing temperature for an annealing time in a range of about 15 minutes to about 280 minutes. The mixture is then cooled at a fixed cooling rate to form the plurality of nanoparticles, wherein the cooling rate is in a range from about 2° C./minute to about 200° C./minute.

The mixture of precursors and hydroxide salt does not include a surfactant. The mixture of precursors and hydroxide salt does not include a nitric salt.

The ratio of spherical particles to cubic particles in the plurality is greater if the isothermic annealing temperature is at the higher end of the range. The ratio of spherical particles to cubic particles in the plurality is greater if the annealing time is at the higher end of the range. The ratio of spherical particles to cubic particles in the plurality is greater if the cooling rate is at the lower end of the range.

The size of a spherical particle is assessed by measuring its diameter. The size of a cubic particle is assessed by measuring its edge length. The average size of the particles is larger when the isothermic annealing temperature is at the greater end of the range. The average size of the particles is larger when the annealing time is at the greater end of the range. The average size of the particles is larger when the cooling rate is at the lower end of the range.

When “precursor 1” is an oxalate; the isothermic annealing temperature is about 520° C.±20° C. or about 520° C.±10%; the annealing time is about 250 minutes±10%; and the fixed cooling rate is about 100° C./minute±50% or about 100° C./minute±10%, then the plurality comprises about 50% single crystalline spherical particles and about 50% cubic particles. The particles have a size of about 422 nm±10%.

When “precursor 1” is an oxalate; the isothermic annealing temperature is about 620° C.±20° C. or about 620° C.±10%; the annealing time is about 230 minutes±10%; and the fixed cooling rate is about 100° C./minute±50% or about 100° C./minute±10%, then the plurality comprises about 65% single crystalline spherical particles and about 35% cubic particles. The particles have a size of about 350 nm±10%.

When “precursor 1” is an oxalate; the isothermic annealing temperature is about 720° C.±20° C. or about 720° C.±10%; the annealing time is about 210 minutes±10%; and the fixed cooling rate is about 100° C./minute±50% or about 100° C./minute±10%, then the plurality comprises about 95% single crystalline spherical particles and about 5% cubic particles. The particles have a size of about 310 nm±10%.

When “precursor 1” is an oxalate; the isothermic annealing temperature is about 720° C.±20° C. or about 720° C.±10%; the annealing time is about 30 minutes±10%; and the fixed cooling rate is about 100° C./minute±50% or about 100° C./minute±10%, then the plurality comprises about 100% cubic particles, or consists essentially of cubic particles. The particles have a size of about 120 nm±10%.

When “precursor 1” is an oxalate; the isothermic annealing temperature is about 720° C.±20° C. or about 720° C.±10%; the annealing time is about 60 minutes±10%; and the fixed cooling rate is about 100° C./minute±50% or about 100° C.±10%, then the plurality comprises about 20% single crystalline spherical particles and about 80% cubic particles. The particles have a size of about 160 nm±10%.

When “precursor 1” is an oxalate; the isothermic annealing temperature is about 720° C.±20° C. or about 720° C.±10%; the annealing time is about 120 minutes±10%; and the fixed cooling rate is about 100° C./minute±50% or about 100° C./minute±10%, then the plurality comprises about 70% single crystalline spherical particles and about 30% cubic particles. The particles have a size of about 265 nm±10%.

When “precursor 1” is an oxalate; the isothermic annealing temperature is about 520° C.±20° C. or about 520° C.±10%; the annealing time is about 70 minutes±10%; and the fixed cooling rate is about 100° C./minute±50% or about 100° C./minute±10%, then the plurality comprises about 10% single crystalline spherical particles and about 90% cubic particles. The particles have a size of about 211 nm±10%.

When “precursor 1” is an oxalate; the isothermic annealing temperature is about 520° C.±20° C. or about 520° C.±10%; the annealing time is about 100 minutes±10%; and the fixed cooling rate is about 100° C./minute±50% or about 100° C.±10%, then the plurality comprises about 15% single crystalline spherical particles and about 85% cubic particles. The particles have a size of about 222 nm±10%.

When “precursor 1” is an oxalate; the isothermic annealing temperature is about 520° C.±20° C. or about 520° C.±10%; the annealing time is about 160 minutes±10%; and the fixed cooling rate is about 100° C./minute±50% or about 100° C./minute±10%, then the plurality comprises about 25% single crystalline spherical particles and about 75% cubic particles. The particles have a size of about 297 nm±10%.

When “precursor 1” is an oxalate; the isothermic annealing temperature is about 520° C.±20° C. or about 520° C.±10%; the annealing time is about 250 minutes±10%; and the fixed cooling rate is about 3.5° C./minute±50% or about 3.5° C./minute±10%, then the plurality comprises about 60% single crystalline spherical particles and about 40% cubic particles. The particles have a size of about 450 nm±10%.

When “precursor 1” is an oxalate; the isothermic annealing temperature is about 720° C.±20° C. or about 720° C.±10%; the annealing time is about 30 minutes±10%; and the fixed cooling rate is about 3.5° C./minute±50% or about 3.5° C./minute±10%, then the plurality comprises about 50% single crystalline spherical particles and about 50% cubic particles. The particles have a size of about 200 nm±10%.

When “precursor 1” is an oxalate; the isothermic annealing temperature is about 720° C.±20° C. or about 720° C.±10%; the annealing time is about 120 minutes±10%; and the fixed cooling rate is about 3.5° C./minute±50% or about 3.5° C./minute±10%, then the plurality comprises about 100% single crystalline spherical particles, or consists essentially of single crystalline spherical particles. The particles have a size of about 300 nm±10%.

Additionally, the average size of the particles is controlled by “precursor 1.” The smallest size particles are generated by acetates. The largest size particles are generated by oxides. Carbonates generate larger particles than oxalates. Typically, oxalates generate particles about 5-7% larger than acetates. Typically, carbonates generate particles about 5-7% larger than oxalates. Typically, oxides generate particles about 40-50% larger than carbonates.

When “precursor 1” is an oxalate; the isothermic annealing temperature is about 720° C.±20° C. or about 720° C.±10%; the annealing time is about 210 minutes±10%; and the fixed cooling rate is about 3.5° C./minute±50% or about 3.5° C./minute±10%, then the plurality comprises about 100% single crystalline spherical particles, or consists essentially of single crystalline spherical particles. The particles have a size of about 320 nm±10%.

When “precursor 1” is an oxide; the isothermic annealing temperature is about 720° C.±20° C. or about 720° C.±10%; the annealing time is about 210 minutes±10%; and the fixed cooling rate is about 3.5° C./minute±50% or about 3.5° C./minute±10%, then the plurality comprises about 100% single crystalline spherical particles, or consists essentially of single crystalline spherical particles. The particles have a size of about 490 nm±10%.

When “precursor 1” is a carbonate; the isothermic annealing temperature is about 720° C.±20° C. or about 720° C.±10%; the annealing time is about 210 minutes±10%; and the fixed cooling rate is about 3.5° C./minute±50% or about 3.5° C./minute±10%, then the plurality comprises about 100% single crystalline spherical particles, or consists essentially of single crystalline spherical particles. The particles have a size of about 340 nm±10%.

When “precursor 1” is an acetate; the isothermic annealing temperature is about 720° C.±20° C. or about 720° C.±10%; the annealing time is about 210 minutes±10%; and the fixed cooling rate is about 3.5° C./minute±50% or about 3.5° C.±10%, then the plurality comprises about 100% single crystalline spherical particles, or consists essentially of single crystalline spherical particles. The particles have a size of about 300 nm±10%.

In another embodiment, the invention includes a method of making a plurality of nanoparticles consisting essentially of single crystalline cubic particles. The method also enables the average size of the cubic particles in a plurality to be controlled. The control is achieved by varying experimental parameters.

The method comprises providing a mixture of precursors and chloride salt. Above is a list of precursors used to make each type of perovskite. Precursor 1 can be made up of only oxalate, only oxide, only carbonate, or only acetate; or can be any mix of oxalate, oxide, carbonate and acetate. The ratio between Precursor 1 and Precursor 2 is approximately 1:1.

In one embodiment, it has been surprisingly found that halogenated salts, such as, for example, salts of fluoride, chloride, bromide or iodide, yields a plurality that consists essentially of (or consists of) single crystalline cubic particles. The “halogenated salt” is halogenated sodium, halogenated potassium or a mix of both. Preferably, the “halogenated salt” is sodium chloride, potassium chloride or sodium chloride/potassium chloride. Preferably a eutectic mixture of salt is used.

The ratio of “precursor 1”:“precursor 2”:halogenated salt is about 1:1:1 to about 1:1:100. Preferably, the ratio of “precursor 1”:“precursor 2”:halogenated salt is about 1:1:20, 1:1:30, or 1:1:40. For example, the ratio of the barium precursor:zirconium precursor:chloride salt is about 1:1:20.

The mixture of precursors and halogenated salt is heated to an isothermic annealing temperature, wherein the annealing temperature is from about 500° C. to about 900° C. The mixture is annealed at the isothermic annealing temperature for an annealing time of about 15 minutes to about 250 minutes. The mixture is then cooled at a fixed cooling rate to form the plurality of nanoparticles, wherein the cooling rate is from about 2° C./minute to about 200° C./minute.

The mixture of precursors and halogenated salt does not include a surfactant. The mixture of precursors and halogenated salt does not include a nitric salt.

The average size of the cubic particles is larger when the isothermic annealing temperature is at the greater end of the range. The size of cubic particles is larger when the annealing time is at the greater end of the range. The size of the cubic particles is larger when the cooling rate is at the lower end of the range.

Additionally, the average size of the particles is controlled by “precursor 1.” The smallest size particles are generated by acetates. The largest size particles are generated by oxides. Carbonates generate larger particles than oxalates. Typically, oxalates generate particles about 5-7% larger than acetates. Typically, carbonates generate particles about 5-7% larger than oxalates. Typically, oxides generate particles about 40-50% larger than carbonates.

Oxalates may also generate particles about 4-20%, 5-15%, or 6-10% larger than acetates. Carbonates may also generate particles about 4-20%, 5-15%, or 6-10% larger than oxalates. Oxides may also generate particles about 30-60%, 45-55%, or 50-70% larger than carbonates.

When “precursor 1” is an oxalate; the isothermic annealing temperature is about 820° C.±20° C. or about 820° C.±10%; the annealing time is about 190 minutes±10%; and the fixed cooling rate is about 3.5° C./minute±50% or about 3.5° C./minute±10%, then the plurality comprises about 100% single crystalline cubic particles, or consists essentially of single crystalline cubic particles. The particles have a size of about 200 nm±10%.

### EXAMPLES

Single-crystalline perovskite BaZrO₃ submicron-sized particles have been synthesized using a simple, scaleable molten salt method. In addition to a time-dependent particle evolution study, the effects of different experimental processing parameters are explored, such as the identity of the salt, annealing temperatures, overall reaction times, cooling rates, and the chemical nature of the precursor in determining their impact upon the purity, size, shape, and morphology of the as-obtained products. The role of additional experimentally controllable factors, such as the heating rate, the amount of salt used, molar ratios of precursors, and surfactant, are explored. By a judicious choice of parameter selection, a rational means of producing pure products with reproducible composition and morphology is provided.

### Experimental Procedures

### Synthesis.

In a typical protocol, barium oxalate (Aldrich, 99.999%), ZrO₂ (Nanostructured & Amorphous Materials Inc., 40-50 nm, 99.9%), and the relevant salt mixture are mixed in a molar ratio of 1:1:20, and ground for 10 min. The mixture was then placed within a porcelain combustion boat (Coors), which was subsequently inserted into a quartz tube and heated to the desired temperature at a rate of 5° C. per min⁻¹, after which the product was isothermally annealed at this preset temperature. After cooling to room temperature at specified cooling rates, samples were subsequently washed with copious amounts of distilled water and heated at 80° C. overnight in a drying oven.

### Characterization.

X-Ray diffraction (XRD). Rapid determination of particle phase was deduced from XRD measurements. An initial approximation of sample purity was achieved without the use of any internal standard. Samples for analyses were prepared by grinding powder thoroughly in ethanol using a mortar and pestle, followed by loading onto glass slides, and subsequent drying in air. Diffraction patterns were collected using a Scintag diffractometer, operating in the Bragg configuration using Cu K_{α} radiation (λ=1.54 Å) from 20 to 65° at a scanning rate of 2° per minute.

The weight percentage of BaZrO₃ in as-prepared samples was obtained via quantitative XRD (Q-XRD). For precise quantitative analysis, the scan rate utilized was 0.2° per minute. Otherwise, parameters used for slit widths and accelerating voltages were identical for all samples. Quantitative analysis was achieved by employing a Rietveld refinement (Bish et al. J. Appl. Cryst., 1988, 21, 86; Orlhac et al. J. Appl. Cryst., 2001, 34, 114) through the mediation of GSAS and EXPGUI software (Bish et al. J. Appl. Cryst., 1988, 21, 86; Toby, B. H. J. Appl. Cryst., 2001, 34, 210); this method is based on the fact that the intensity diffracted by a crystalline phase is essentially proportional to the quantity of the diffracting material. Hence, this protocol relies on theoretically reconstructing the entire diffraction profile by gradual refinement of relevant unit cell, structural parameters, and phase constituents. Structure models for various compounds used in the calculations including BaCO₃, ZrO₂, BaZrO₃, and ZrSiO₄ as well as crystallographic information files were obtained from the literature. (Smith et al. Acta Crsytallogr., 1965, 18, 983; Robinson et al. Amer. Miner., 1971, 56, 782; De Villiers, J. P. R. Amer. Miner., 1971, 56, 758; Levin et al. J. Solid State Chem., 2003, 175, 170.) Calculated patterns were noted to fit reasonably well with measured data, from which precise weight percents of the various chemical constituents could then be extracted.

For samples requiring a more accurate quantitative analysis of composition, a known quantity of zirconium silicate (ZrSiO₄, Acros, 99%), which was utilized as an internal standard, was carefully combined with as-prepared zirconate samples. (Eckert Jr. et al. J. Am. Ceram. Soc., 1996, 79, 2929.) That is, the exact amount of internal standard used was set at 25% by careful rendering of the final weight ratio of the internal standard to that of the as-prepared sample as 1:3.

X-Ray photoelectron spectroscopy (XPS). Elemental analysis was obtained by X-Ray photoelectron spectroscopy (XPS). Pressed wafers or cut sections of the samples were attached to stainless steel sample holders using conductive double-sided carbon tape and installed in the vacuum chamber of a Model DS800 XPS surface analysis system (Kratos Analytical Plc of Manchester, UK). The chamber was evacuated to a base pressure of ˜5·10⁻⁹ torr. A hemispherical energy analyzer was used for electron detection. XPS spectra were collected using a magnesium K-alpha X-ray source at an 80 eV pass energy and in 0.75 eV steps for each sample survey spectrum. These data were used to generate estimates of the atomic and weight concentrations of the elements present in the samples.

Electron microscopy. The particle size and morphology of the resulting as-prepared products were initially characterized using a field emission scanning electron microscopy instrument (FE-SEM Leo 1550), operated at accelerating voltages of 15 kV and equipped with energy-dispersive X-ray spectroscopy (EDS) capabilities. Samples were deposited onto conductive carbon tapes, which were subsequently attached to the surfaces of SEM brass stubs. These samples were then conductively coated with gold by sputtering for 20 sec to minimize charging effects under SEM imaging conditions.

Specimens for transmission electron microscopy (TEM) and high-resolution TEM (HRTEM) were obtained by drying droplets of BaZrO₃ samples from an ethanolic dispersion onto a 300 mesh Cu grid, coated with a lacey carbon film. TEM images were taken at an accelerating voltage of 120 kV on a Philips CM 12 instrument. HRTEM images and electron diffraction patterns were obtained on a JEOL 2010F HRTEM at an accelerating voltage of 200 kV. This instrument was equipped with an Oxford INCA EDS system with the potential of performing selected area electron diffraction (SAED) to further characterize the crystallinity of as-prepared barium zirconate structures.

### Results

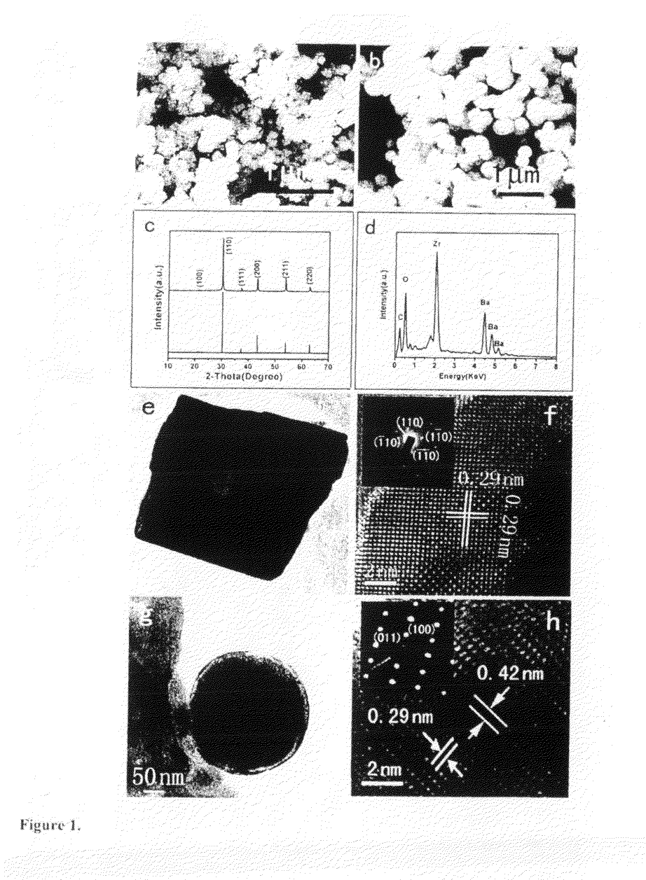

Cubic BaZrO₃ particles (FIG. 1a, edge length measuring 120±25 nm based on a measurement of 50 particles) could be prepared by heating precursors in a NaOH—KOH mixture (49.2:50.8 molar %; m.p. 170° C.) to 720° C. Annealing of this sample at this temperature ensued for 30 min, followed by subsequent quenching of this sample to room temperature at an average rate of 100° C. per minute. Conversely, for spherical particles (FIG. 1b, diameter of 320±100 nm based on a measurement of 50 particles), mixtures were annealed for 3.5 h at 720° C., followed by gradual in situ furnace cooling to room temperature at an average rate of 3.5° C. per minute.

XRD patterns and EDS spectra for the two samples are identical within error as well as with expected results. Hence, a representative XRD pattern (FIG. 1c) and EDS spectrum (FIG. 1d) are shown. The EDS spectrum confirms the presence of Ba, Zr, and O. In addition, the XRD peaks can be readily indexed to the cubic phase (space group: Pm3m) of BaZrO₃ with the calculated lattice constant of a=0.4183 nm, in good agreement with literature (a=0.4181 nm, JCPDS No. 06-0399). Based on analysis of expected peak positions in XRD patterns, it is fairly confident that neither Ba₂ZrO₄ nor Ba₃Zr₂O₇ formed in any measurably significant quantities. The Ba 3d_{3/2} and 3d_{5/2} peaks are located at 794.42 eV and 779.11 eV, respectively, whereas the Zr 3d_{3/2} and 3d_{5/2} peaks are situated at 183.23 eV and 180.87 eV, respectively. (Fuenzalida et al. J. Mater. Res., 1995, 10, 2749; Lyapin et al. Surf Interface Anal., 2004, 36, 989.) These data are consistent with the oxidation states of Ba and Zr, as being +2 and +4, respectively, which are expected of BaZrO₃ formation.

The TEM image (FIG. 1e) shows the cubic morphology of a typical individual particle. The HRTEM image and associated SAED pattern obtained from the [001] projection (FIG. 1f and corresponding inset) suggest the single-crystalline nature of the particle with no apparent defects and dislocations. The spacing of the observed lattice fringes has been deduced to be 0.29 nm, which can be associated with the {110} plane of the cubic phase of BaZrO₃. By comparison with BaZrO₃ cubes, BaZrO₃ spheres (FIG. 1g) are also single-crystalline with no apparent defects and dislocations. The spacings of observed lattice fringes are 0.29 nm and 0.42 nm, respectively, and have been correspondingly indexed to the {011} and {100} planes of the cubic phase of BaZrO₃ in agreement with the SAED pattern (inset of FIG. 1h).

To demonstrate the effect of different reaction parameters with respect to phase purity and particle morphology of BaZrO₃, a series of systematic experiments were performed, as delineated in Table 1. Experimental variables were carefully crafted so that the behavior of subsets of samples could be reliably compared across individual, discrete parameters, with all other parameters kept constant.

As an example, when examining samples annealed at different temperatures (samples G to I), even though the times required to attain the desired annealing temperatures were different, overall reaction times remained constant. This feat was accomplished partly by quenching samples to room temperature at a very high average rate of 100° C. min⁻¹ in order to minimize the possible time differential resulting from cooling, starting from these various, different temperatures.

### Selection of Salt

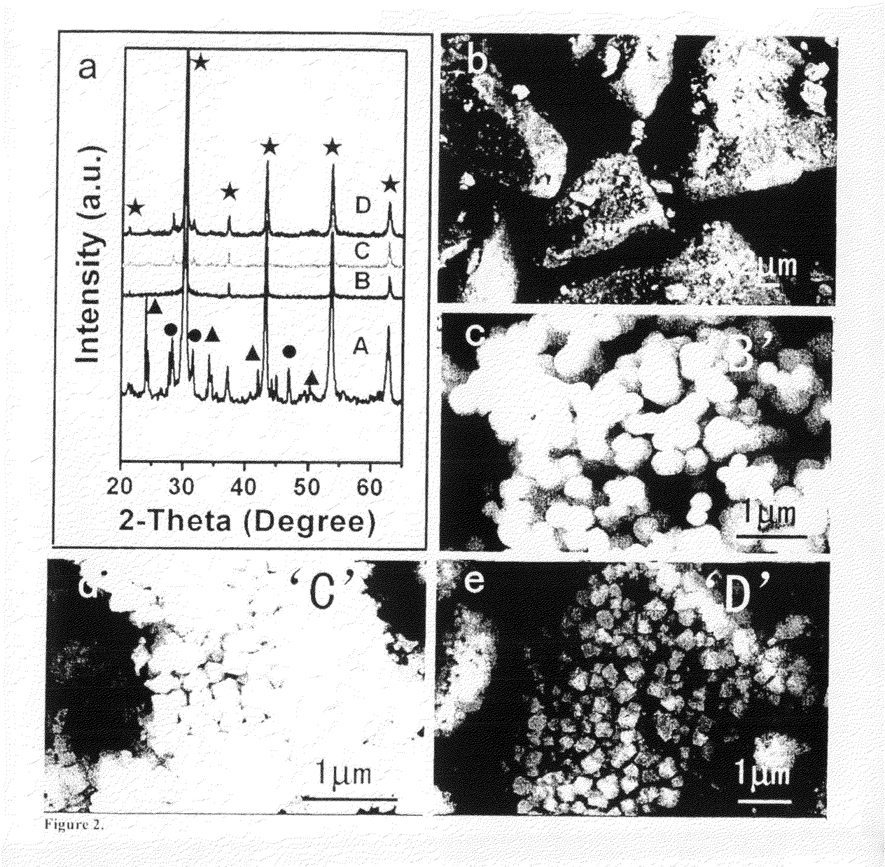

As shown in FIG. 2a, regardless of the overall reaction time, sample A, prepared in the absence of salt, contains not only BaZrO₃ but also impurity phases which can be attributed to BaCO₃ and ZrO₂, respectively. Although the decomposition temperature of BaCO₃ is expected to be around 821° C., (Barin, I. Thermochemical properties of inorganic substances; Springer-Verlag: New York, 1973.) the appearance of BaCO₃ may arise from the recombination of CO₂ and BaO during the cooling process.

A number of samples were subsequently prepared by running molten salt reactions above the melting points of various salt media tried. Hence, the weight percentage of BaZrO₃ increased from 69% (sample A, no salt used) to 93.3% (sample D) in the presence of NaCl (Fisher; m.p. 801° C.) and to 93.9% (sample C) in a mixture of NaCl/KCl (50:50 mole % ratio; m.p. 658° C.). In the presence of NaOH/KOH (49.2:50.8 mole % ratio; m.p. 170° C.) as the eutectic salt mixture, BaZrO₃ with a weight percentage of almost 100% could be generated at rather low temperatures; interestingly, this sample (sample B) remained compositionally stable even upon annealing to 820° C. It is noteworthy that in salt media such as NaNO₃ (J. T. Baker Chemical Co.; m.p. 310° C.) and NaNO₃/NaCl (93.6:6.4 mole % ratio; m.p. 294.7° C.), comprising samples E and F, from the XRD pattern, no BaZrO₃ was synthesized at all, even at the same overall reaction times as the other samples and even after annealing at 320° C. It should be noted that in these specific systems, higher annealing temperatures (such as 700 to 800° C.) were not used because salts such as NaNO₃ will decompose above 380° C. Nonetheless, overall, the apparent lack of barium zirconate particle formation using nitrate salts was a surprising result because there have been reports of perovskite particle aggregate formation in the presence of molten alkali metal oxonitrates. (Deloume et al. J. Mater. Chem., 1999, 9, 107.)

A discussion of the effect of the choice of salt selection and of temperature follows. Molten salt solutions can actually partake of several functions (Braunstein et al. Advances in Molten Salt Chemistry; Plenum Press: New York, 1973). They can either catalyze reactions (Sundermeyer, W. Chem. Ber., 1964, 97, 1069); participate in reactions themselves by consuming one of the reagents (Liu et al. Nano Lett., 2006, 6, 1535), or merely act as a non-interfering solvent for the reagents (Mao et al. J. Am. Chem. Soc., 2003, 125, 15718). However, in every case, the intrinsic solubilities of individual precursor molecules within these particular solvents are critical.

Thus, though salts such as NaNO₃ and NaNO₃/NaCl possess relatively low melting temperatures (˜200-300° C.), few precursor molecules of the different reacting species will adequately dissolve and diffuse in these particular solvents under such conditions, meaning that the corresponding reaction rates are low. Therefore, little, if any, BaZrO₃ forms. By contrast, at high temperatures such as ˜800° C., in the presence of NaCl, precursor molecules will more readily disperse, dissociate, rearrange, and then diffuse rapidly throughout the salt, forming a reasonably homogeneous solution, that fosters rapid reaction. Higher temperatures therefore not only increase the flux and mobility of reactive components, but also imply a lower viscosity within the reaction medium, all of which is consistent with a high rate of reactivity. (Bloom, H. The Chemistry of Molten Salts; W. A. Benjamin, Inc.: New York, 1967.) Thus, overall, as compared with samples prepared in the absence of salt (e.g., sample A), it is evident that the presence of either a chloride or hydroxide salt medium encouraged the formation of BaZrO₃ (e.g., samples B to D).

The effect of using a hydroxide salt can be summarized as follows. It turns out that hydroxide ion can actively participate in the reaction itself. For instance, it has been shown that molten hydroxide solutions (Liu et al. ano Lett., 2006, 6, 1535.) will not only react with metallic salts but also with metal oxides present. A plausible formation scheme (e.g., sample B) for BaZrO₃ is given in the presence of NaOH as the salt medium:

BaC₂O₄+2NaOH+ZrO₂→Na₂CO₃+BaZrO₃+H₂O+CO (1)

In the absence of hydroxide ion (e.g., sample E), a correspondingly viable reaction scheme is proposed as:

BaC₂O₄+ZrO₂→BaZrO₃+CO+CO₂ (2)

The thermodynamic Gibbs' free energies for each of these reactions at increasing annealing temperatures were calculated, as shown in Table 2. (Barin, I. Thermochemical properties of inorganic substances; Springer-Verlag: New York, 1973.) There are two trends worth noting. First, as expected, as the temperature progresses from 520 to 720° C., the corresponding free energy values effectively double in magnitude, which is conducive to barium zirconate formation at higher temperatures. Second, the free energy values in the presence of hydroxide ion are ˜100 kJ/mol more favorable for the reaction to occur; for instance at 720° C., the free energy value for barium zirconate synthesis is approximately −439 kJ/mol in the presence of hydroxide ion, whereas in the absence of hydroxide ion, the corresponding free energy value is −341 kJ/mol. The large apparent difference in free energy of reaction coupled with the relatively high solubility and reactivity of metal species in hydroxide media can therefore explain the relative ease and overall completeness of BaZrO₃ formation that was observed.

The nature of the salt media also has an impact on the morphology of the as-prepared products; Ito et al. demonstrated this assertion in the synthesis of PbTiO₃ particles wherein cubic and rectangular particles were produced in the presence of KCl and LiF, respectively (Ito et al. J. Am. Ceram. Soc., 1995, 78, 2695; Ito et al. Proceedings of the 2000 IEEE International Symposium on Applications of Ferroelectrics, 2000; Vol. 1, pp 389). A similar effect is shown in FIGS. 2b to 2e. In the absence of salt, products aggregated as large agglomerates (FIG. 2b). In chloride-containing media, cubic particles were obtained (FIGS. 2d & 2e), whereas spherical particles were more readily found in hydroxide-containing media (FIG. 2c). The shape of a nanocrystal, i.e., the reason for the morphology difference, is often determined by the relative specific surface energies associated with the facets of the crystal. As supporting evidence, the presence of different crystalline surface planes formed are noted, when comparing the TEM images of as-prepared BaZrO₃ cubes vs. spheres in FIGS. 1f and 1h. Hence, it is likely that the preferential adsorption of molecules and ions, such as chloride vs. hydroxide, to different crystal faces likely directs the growth of nanoparticles to their ultimate product morphology by controlling the growth rates along the different crystal faces. (Murphy, C. J. Science, 2002, 298, 2139; Puntes et al. Science, 2001, 291, 2115; Filankembo et al. J. Phys. Chem. B, 2003, 107, 7492.) This effect is analogous to the use of surfactants in other synthetic systems in order to achieve shape control. (Xia et al. Adv. Mater., 2003, 15, 353; Lee et al. Adv. Mater., 2003, 15, 441.)

Another key point has been the dispersability factor. Because of the relatively high viscosity of hydroxide (Liu et al. Nano Lett., 2006, 6, 1535), as-prepared particles grown in hydroxide media tend to be more dispersed and isolated than those fabricated in chloride media. Thus, the use of different salt species not only has an impact on the ease of reaction but also correlates with the morphology of the as-prepared product. It should be mentioned that since hydroxide media tend to yield the best samples in terms of purity, morphology and dispersion, the remainder of the paper will primarily focus on samples prepared using this medium with careful and rational control over a number of other different variables.

### Annealing Temperature

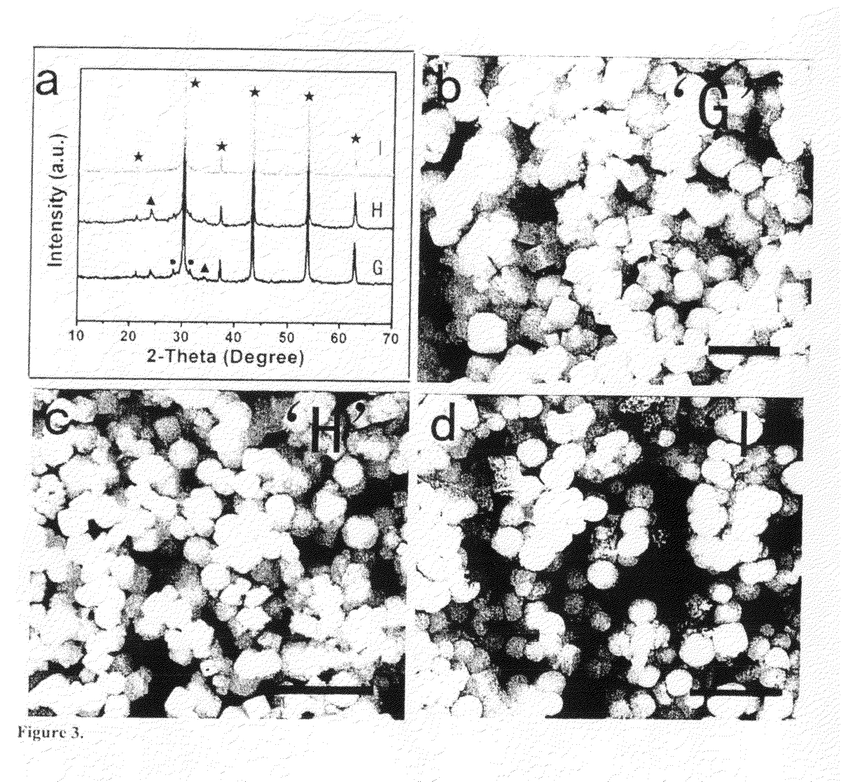

As previously noted, the solubility and reactivity of precursors increase with increasing annealing/reaction temperature of the solvent medium itself. Moreover, it is known that the viscosity of the molten salt decreases rapidly with an increase of temperature, thereby greatly facilitating the diffusion of precursor species in the solvent itself. (Bloom, H. The Chemistry of Molten Salts; W. A. Benjamin, Inc.: New York, 1967.) These effects have been studied in the series of samples G, H, and I, which had been annealed at 520, 620, and 720° C., respectively, with constant overall reaction times (350 min) and rapid cooling rates (100° C./min). Associated data are shown in FIG. 3. From XRD data, it is noted that the weight percentage of BaZrO₃ in the sample correlate well with increasing annealing temperature, starting from 84% (sample G) to 95% (sample H). Essentially no impurity phase was detected at the highest temperature, 720° C. (sample I), implying higher rates of reactivity and essentially full conversion to barium zirconate at the highest annealing temperatures.

Another key issue is product morphology. Whereas sample B, which had been slowly cooled to room temperature from an annealing temperature of 720° C., resulting in an effectively longer reaction time sequence, consisted of ˜100% spherical particles, samples G to I, which had been rapidly quenched, possessed varying percentages of cubes and spheres. In fact, the percentage of spheres increased from 50% in sample G to 65% in sample H and finally, to 95% in sample I with increasing annealing temperature. Hence, these observations suggest that higher annealing temperatures and longer overall reaction times are conducive to the production of relatively pure, spherically shaped zirconate samples.

### Impact of Overall Reaction Time

To explore the effect of overall reaction times more thoroughly, samples J, K, L, and I were prepared at an identical temperature (i.e. 720° C.) but with different annealing times and reaction times (e.g., ranging from 170 min to 350 min). All of these samples contained ˜100 weight percent of barium zirconate with no detectable impurity.

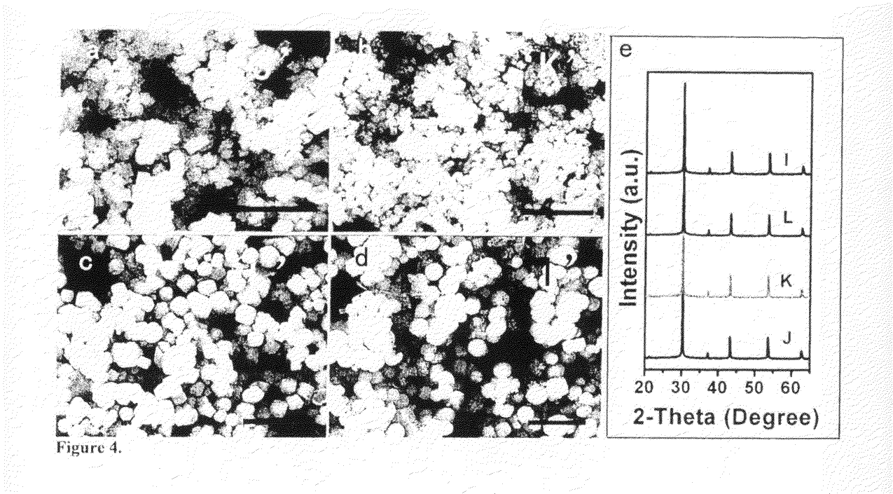

In terms of morphology, as shown in FIG. 4, sample J, synthesized with the least amount of reaction time (170 min), contained primarily cubes. As the overall annealing/reaction time was systematically increased, the percentage of spheres also increased from 20% in sample K (200 min of reaction time) to 70% in sample L (260 min of reaction time). Ultimately, in sample I, fabricated with a reaction time of 350 min, the proportion of spheres was ˜95%. Simultaneously, the average diameter of particles increased accordingly from 120 nm for sample J, 160 nm for sample K, 265 nm for sample L, and finally to 310 nm for sample I. Hence, it was evident that with increasing annealing time, the samples progressed from cubes to spheres with a corresponding, simultaneous increase in particle size.

A parallel sample series (e.g. G, M, N, O) was prepared by annealing at a lower temperature (520° C.), while systematically varying annealing times from 170 to 350 min. The weight percentage of BaZrO₃ phase increased from 29% in sample M, synthesized after reaction for 170 min, to as much as 84% in sample G, produced after 350 min of annealing. An analogous increase in diameter as well as in the percentage of spheres in samples that had undergone additional annealing was also observed. That is, a progression from ˜10% spheres in sample M to ˜50% spheres in sample G was observed, supportive of the assertion that the conversion rate from cubes to spheres is favored at higher annealing temperatures. (Zhou et al. J Mater. Chem., 2007, 17, 1707.) In this span of samples, average particle diameters increased from ˜211 nm to as much as ˜422 nm, suggesting that increasing annealing times favors particle growth.

### Influence of Cooling Rates

In the vast majority of papers dealing with molten salt synthesis, either a slow cooling rate or an unimpeded furnace cooling is utilized (Mao et al. J. Am. Chem. Soc., 2003, 125, 15718; Mao et al. Adv. Mater., 2005, 17, 2194; Park et al. Chem. Mater., 2006, 18, 5289). By contrast, in other techniques, such as co-precipitation, quenching, i.e., the idea of a very rapid cooling, is frequently used to control not only nucleation but also the subsequent growth, formation, and morphology of product particles.

In this specification, the effect of cooling rates in molten salt systems was studied by comparing samples prepared by varying quenching rates. For instance, sample P (˜450 nm) was synthesized under exactly the same conditions as sample G (˜422 nm), with the exception that the former was cooled at a rate of 3.5 vs. 100° C./min. However, Sample P was essentially 100% pure, whereas sample G still possessed a detectable level of impurities. Thus, decreasing the cooling rate had the practical effect of increasing the overall reaction time, thereby allowing for increased reactivity of precursor molecules and therefore, improved sample quality.

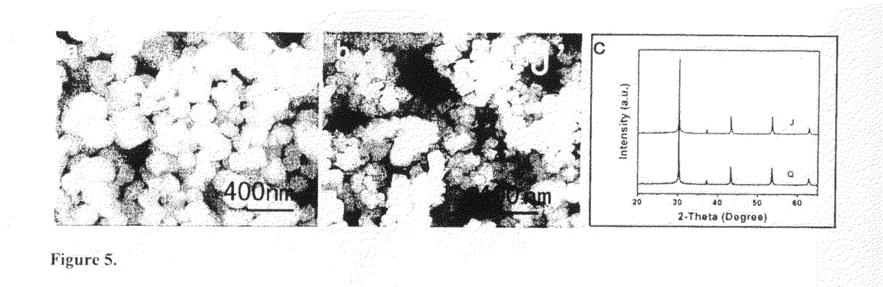

As noted earlier, increasing annealing time favored the formation of spheres in the products. The overall reaction time for the second pair of samples tested was 170 min. Hence, sample J (˜120 nm) cooled at a rate of 100° C./min embodied almost exclusively cubes, whereas sample Q (˜200 nm), prepared identically but cooled at 3.5° C./min, contained a mixture of cubes and spheres (FIG. 5). The overall reaction time for the third pair of samples tested was 260 min. Sample R (˜300 nm) cooled at a rate of 3.5° C./min was characterized by spheres. By contrast, sample L (˜265 nm), prepared identically but cooled at a rate of 100° C./min, was more heterogeneous with a noticeable quantity of cubes in addition to spheres.

In every case, samples that had been more slowly quenched at 3.5° C./min tended to possess larger particles on average than those samples that had been more rapidly quenched at 100° C./min. In addition, at any given annealing temperature, a slower cooling rate promotes the formation of spheres within the sample. Overall, these observations can be explained as follows. Both longer annealing times and higher annealing temperatures are conducive to the production of larger barium zirconate particles. Therefore, the results demonstrate that quenching in and of itself can be viably used in molten salt systems as a rational synthetic parameter not only to control particle growth but also to generate particles of a specific morphology, which could not otherwise be obtained under standard cooling conditions. (Zhou et al. J. Mater. Chem., 2007, 17, 1707.)

### Choice of Precursors

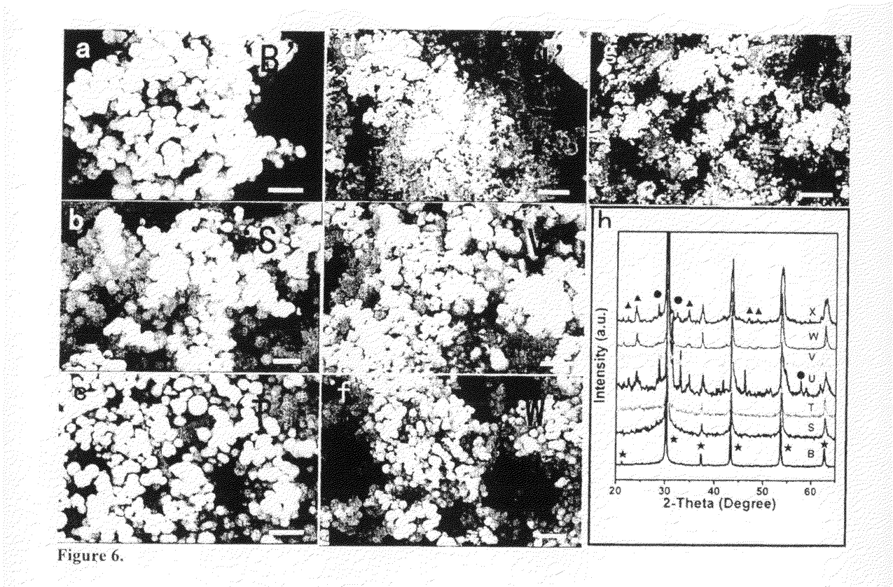

From FIG. 6, it is noted that replacing barium oxalate (sample B) with either barium oxide (sample S) or barium carbonate (sample T) also yielded samples possessing relatively high purity as well as uniform monodisperse spherical morphology. Similarly, sample W, synthesized using barium acetate, is composed of a large proportion of spherical particles, as was the case with samples B, S, and T, but was observed to possess significant oxide impurities, such as BaCO₃ and ZrO₂. By contrast, samples synthesized with either chloride-containing or nitrate-containing precursors of barium and of zirconium (samples U, V, and X) not only tended to be relatively impure with the presence of BaCO₃ and ZrO₂ but also were composed of large particle aggregates, measuring 1 to 2 microns.

Thermodynamically speaking, by altering the chemical identity of precursors, the values of the Gibbs' free energies of reactions is changed in a parallel fashion. In fact, comparing BaCl₂, Ba(NO₃)₂, and barium oxalate at 720° C., the corresponding Gibbs' free energies of reactions are computed to be −93 kJ/mol, −80 kJ/mol, and −379 kJ/mol, respectively. The large magnitude of the free energy parameter associated with barium oxalate clearly suggests that it is a highly favorable reaction and the purity of our products supports that assertion. However, it should be noted that high-quality barium zirconate particles were formed using BaO and BaCO₃ as precursors, even though the Gibbs' free energies for these reactions were −50 kJ/mol and −54 kJ/mol, respectively. Hence, it is expected that the reasons for the observed differences in purity and morphology as a function of precursor are not necessarily solely thermodynamic but rather are also dependent on a number of other factors including solubility, diffusion, and transport of reagent species within the reaction medium, all of which suggest a kinetic explanation for the observations.

### Additional Factors

A number of other factors likely play a role in morphology, purity, and composition. First, the addition of surfactant does not necessarily aid in enhancing product purity but in fact, may simply assist in dispersing the product powder. Second, the amount of salt used in the reaction is also significant; addition of excess salt can decrease impurity levels by favoring full dissolution and solubilization of precursors and subsequent precipitation of nuclei of the perovskite phase. In fact, perovskite particles have been noted to increase in size with increasing relative salt content. (Yoon et al. J. Mater. Sci., 1998, 33, 2977; Yoon et al. J. Am. Ceram. Soc., 1993, 76, 1373.) Third, the relative molar stoichiometry of precursors either with or without surfactant could control the aspect ratio of as-prepared Bi₂Fe₄O₉ nanoparticles. (Park et al. J. Mater. Chem., 2005, 15, 2099.) That is, whereas use of a 1:1 molar ratio of Bi³⁺ to Fe³⁺ precursors generated smaller sized particles with cubic-like features, the highest molar ratio employed, i.e. 6:1 molar ratio of Bi³⁺ to Fe³⁺, yielded larger-sized structures with rod-like, rectangular shapes. Preliminary results with barium zirconate are suggestive of similar behavior in this system. Fourth, overly high heating rates will increase the quantity of impurities, likely because of non-optimized reaction kinetics. Fifth, even the nature of the combustion boat may conceivably affect the purity of the product. For instance, it is noted that hydroxide media can potentially react with the porcelain boat itself. Moreover, in the samples, on average, 1.41% Na and 2.28% K were found, based on XPS results. A preliminary analysis of as-obtained EDS results, in support of the presence of impurities, suggests that there is ˜1.81% Na and ˜1.12% K in the samples. It is noted that the structural character of the samples (namely the fact that the particles are relatively small and particulate in nature) can impact the accuracy of EDS data and may account for the numerical discrepancies observed relative to that of the XPS data. Nonetheless, overall, based on the spectroscopic data, it is reasonable to ascribe the appearance of Na and K to residues from the salt mixture and the additional presence of Si to the reaction crucible itself. The possible formation of either sodium silicate or potassium silicate cannot fully be discounted though it was likely to be insignificant. Any C observed would have resulted from contaminant sources such as CO₂ physisorbed on the surface of BaO. (Mao et al. Adv. Mater., 2005, 17, 2194.)

### Mechanistic Insights: Time-Dependent Particle Formation

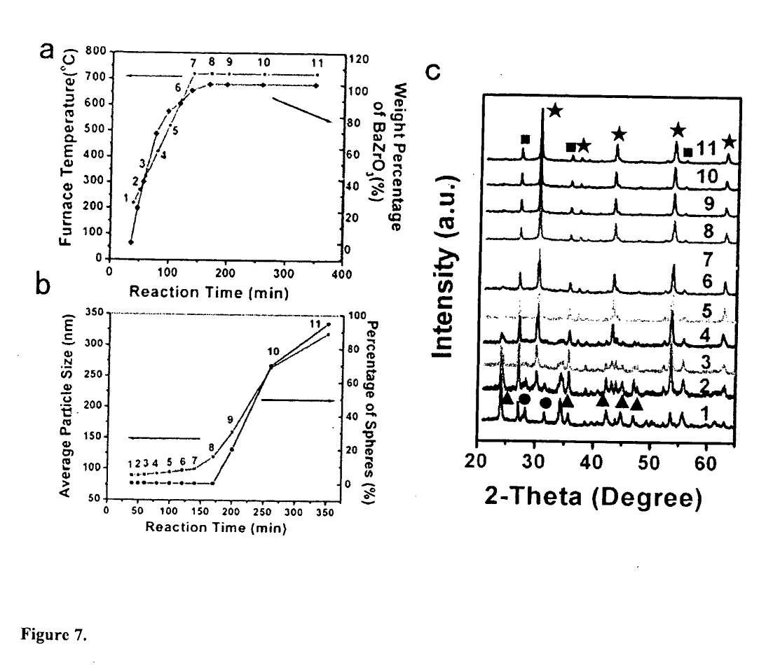

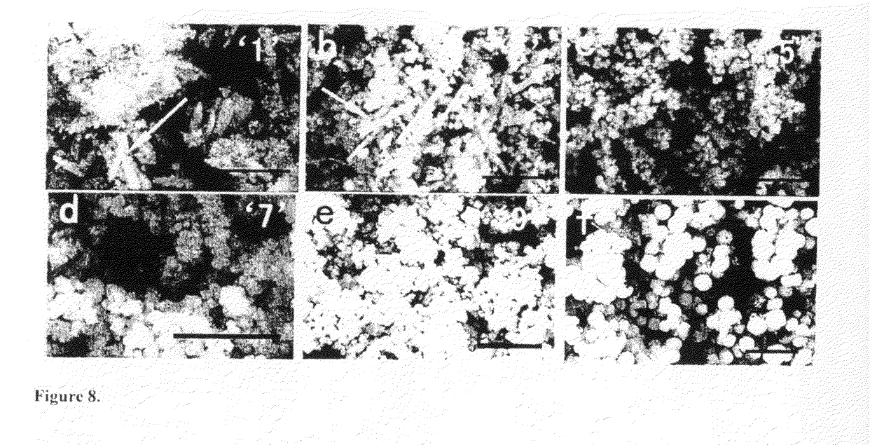

To gain insights into the mechanism of BaZrO₃ particle formation in the presence of NaOH/KOH, a series of samples (#1-11) corresponding to successive temporal growth stages during the formation of sample I (which had been annealed at 720° C. for 210 min) was synthesized. Descriptions are shown in FIGS. 7a and b as well as in Table 3, with samples 8 to 11 in Table 3 corresponding to samples J, K, L, and I from Table 1. Rod-like motifs, as shown by arrows in FIGS. 8a, 8b, S7a, and S7b, initially appeared in samples 1 to 4, at reaction temperatures ranging from 220 to 420° C., and may be attributable to the formation of barium carbonate. (Wang et. al. Chem. Lett., 2003, 32, 594.) EDS analysis for all samples was consistent with the presence of Ba, Zr, O and C peaks, as expected. It should be noted that the ratio of intensities of the Zr vs. Ba signals ascribed to as-prepared rods was considerably lower than that for the corresponding, analogous particles, implying that these rods may have consisted of a mixture of ZrO₂, BaO, and BaCO₃.

Weight percentages of BaZrO₃ of these samples have been calculated based on the XRD patterns shown in FIG. 7c. Average particle sizes and percentage of spheres within samples were obtained from SEM images shown in FIG. 8. Sample 1, quenched at 220° C., did not yield any crystalline BaZrO₃. Sample 2, quenched 10 minutes later at 270° C., consisted of 21.7% BaZrO₃; small cubic particles, measuring ˜90 nm, were observed. From sample series 2 to 8, the weight percentage of BaZrO₃ increased dramatically from 21.7% associated with sample 2 (which had been prepared at 270° C. after 50 min of reaction time) to 96.1% associated with sample 7, (which had been synthesized at 720° C. after 140 min of reaction time). Overall data are summarized in Table 3.

Reaction at 720° C. yielded the best results in terms of sample purity. Over this particular sample set from 1 through 7, particle size did not vary significantly (range of 90 to 100 nm), but the cube morphology predominated (FIG. 7b). Increasing the overall reaction time further from 170 to 350 min (e.g. samples 8 to 11) not only increased the weight percentage of BaZrO₃ obtained to ˜100% but also basically tripled particle sizes from ˜100 nm to >300 nm in diameter. Moreover, these latter samples possessed increasingly larger percentages of spherical particles.

Without wanting to be bound by a theory, the following mechanism is proposed. Upon heating of the initial mixture, the precursors dissolve into the resultant molten flux and gradually form BaZrO₃, which itself has limited solubility. Upon attainment of a level of concentration supersaturation above the critical solubility (i.e. above the critical energy barrier) of barium zirconate required for the formation of nuclei, cubic particles are initially generated. Hence, increasing the annealing temperature has the practical effect of favoring the formation of BaZrO₃, thereby increasing its nucleation rate, and generating a large quantity of initial cubic seed particles. This reasonable hypothesis (i.e. the formation of these seed particles) may explain why particles synthesized at higher temperatures at identical reaction times are actually smaller than those produced at lower temperatures (samples G through I). Moreover, because these initial cubic seed nuclei particles are likely to be below the critical particle size necessary for an in situ conversion, the implication is that particle transformation from cubes to spheres is not as favored at first.

That is, once nucleation occurs, particle growth occurs simultaneously (samples 2 to 8). The conversion of cubes to spheres also appears as a parallel process, upon attainment of a critical particle size for the cube precursors (samples 9 to 11). Overall, it is reasonable to assume that there is a critical, threshold concentration required for the initial nucleation and formation of the cubes as well as a critical nucleus dimension for these cubes to acquire prior to their transformation into spheres. Growth and conversion trends converged for samples 9 to 11 with the formation of samples containing predominantly large spheres (>300 nm).

### Observations

Different parameters (such as salt, surfactant, reaction temperature, reaction time, precursor type, amount of salt, heating rates, and precursor ratios) affect resultant product purity, size, shape, and morphology. Among these various parameters, the selection of salt is likely the most important one, because solubility and reactivity effects associated with the salt can alter the synthesis process as well as the resultant particle size and shape.

In general, the production of relatively high-quality barium zirconate samples was also favored by high annealing temperatures, slow cooling rates, and overall long reaction times. In terms of optimal overall reaction conditions, the most uniform, crystalline, well-dispersed, and chemically homogeneous BaZrO₃ submicron-sized particles were obtained using BaC₂O₄ and ZrO₂ as precursors; NaOH/KOH as the molten reaction medium; a molar ratio of BaC₂O₄:ZrO₂:salt corresponding to 1:1:20; a heating rate of 5° C./min; as well as a reaction temperature of 720° C. Shorter annealing times (e.g. 30 min) coupled with higher cooling rates (e.g. 100° C./min) favored the production of smaller-sized cubic particles. By contrast, longer annealing times (e.g. 60-210 min) and/or slower cooling rate (5° C./min) induced particle conversion from cubes to spheres and usually resulted in a mixture of cube and sphere morphological motifs. Either increasing the annealing time or slowing the cooling rates resulted in the formation of larger-sized spherical particles. Most importantly, it has been shown that reliable size, shape, and composition control can be achieved in molten salt syntheses by judicious parameter selection.

Thus, while there have been described what are presently believed to be the preferred embodiments of the present invention, those skilled in the art will realize that other and further embodiments can be made without departing from the spirit of the invention, and it is intended to include all such further modifications.

TABLE 1
Table 1. Barium zirconate samples systematically prepared with different processing parameters
at a constant heating rate of 5° C. min⁻¹. Variables controllably altered in each series are in
boldface.

| | | | | | | | | | Product |
|---|---|---|---|---|---|---|---|---|---|
| | | | | | | | | | Description |
| | | | | | Time | Time | | | (observed |
| | | | | | Required | Sample was | | | compound; |
| | | | | | to Attain | Maintained | | | percent purity; |
| | | | | | Desired | at Desired | Overall | Cooling | average particle |
| | | | | Annealing | Annealing | Annealing | Rxn | Rate | size; |
| Parameter | | | | Temp. | Temp. | Temp. | time | (° C./ | morphology |
| Varied | Sample | Precursors | Salt | (° C.) | (minutes) | (minutes) | (min.) | min) | distribution) |
| Salt | A | BaC₂O₄, ZrO₂ | No salt | 820 | 160 | 190 | 350 | 3.5 | BaZrO₃ (69%, |
| | | | | | | | | | aggregates) with |
| | | | | | | | | | BaCO₃ and ZrO₂ |
| | B | BaC₂O₄, ZrO₂ | NaOH/ | 720 | 140 | 210 | 350 | 3.5 | BaZrO₃ (100%; |
| | | | KOH | | | | | | ~320 nm; 100% |
| | | | | | | | | | spheres) |
| | C | BaC₂O₄, ZrO₂ | NaCl/KCl | 820 | 160 | 190 | 350 | 3.5 | BaZrO₃ (93.9%; |
| | | | | | | | | | ~200 nm; cubes) |
| | | | | | | | | | with BaCO₃ & |
| | | | | | | | | | ZrO₂ |
| | D | BaC₂O₄, ZrO₂ | NaCl | 820 | 160 | 190 | 350 | 3.5 | BaZrO₃ (93.3%; |
| | | | | | | | | | ~200 nm; cubes) |
| | | | | | | | | | with BaCO₃ & |
| | | | | | | | | | ZrO₂ |
| | E | BaC₂O₄, ZrO₂ | NaNO₃ | 320 | 60 | 290 | 350 | 3.5 | No BaZrO₃. |
| | | | | | | | | | Impurities of |
| | | | | | | | | | BaCO₃ & ZrO₂ |
| | F | BaC₂O₄, ZrO₂ | NaNO₃/ | 320 | 60 | 290 | 350 | 3.5 | No BaZrO₃. |
| | | | NaCl | | | | | | Impurities of |
| | | | | | | | | | BaCO₃ & ZrO₂ |
| Annealing | G | BaC₂O₄, ZrO₂ | NaOH/KOH | 520 | 100 | 250 | 350 | 100 | BaZrO₃ (84%; |
| Temp. | | | | | | | | | ~422 nm 50% |
| | | | | | | | | | cubes/50% |
| | | | | | | | | | spheres) with |
| | | | | | | | | | BaCO₃ and ZrO₂. |
| | H | BaC₂O₄, ZrO₂ | NaOH/KOH | 620 | 120 | 230 | 350 | 100 | BaZrO₃ (95%; |
| | | | | | | | | | ~350 nm; 35% |
| | | | | | | | | | cubes/65% |
| | | | | | | | | | spheres) with |
| | | | | | | | | | BaCO₃ and ZrO₂. |
| | I | BaC₂O₄, ZrO₂ | NaOH/KOH | 720 | 140 | 210 | 350 | 100 | BaZrO₃ (100%; |
| | | | | | | | | | ~310 nm; 5% |
| | | | | | | | | | cubes/95% |
| | | | | | | | | | spheres) |
| Annealing | J | BaC₂O₄, ZrO₂ | NaOH/KOH | 720 | 140 | 30 | 170 | 100 | BaZrO₃ (100%; |
| Time | | | | | | | | | ~120 nm; 100% |
| | | | | | | | | | cubes) |
| | K | BaC₂O₄, ZrO₂ | NaOH/KOH | 720 | 140 | 60 | 200 | 100 | BaZrO₃ (100%; |
| | | | | | | | | | ~160 nm; 80% |
| | | | | | | | | | cubes/20% |
| | | | | | | | | | spheres) |
| | L | BaC₂O₄, ZrO₂ | NaOH/KOH | 720 | 140 | 120 | 260 | 100 | BaZrO₃ (100%; |
| | | | | | | | | | ~265 nm; 30% |
| | | | | | | | | | cubes/70% |
| | | | | | | | | | spheres) |
| | I | BaC₂O₄, ZrO₂ | NaOH/KOH | 720 | 140 | 210 | 350 | 100 | BaZrO₃ (100%; |
| | | | | | | | | | ~310 nm; 5% |
| | | | | | | | | | cubes/95% |
| | | | | | | | | | spheres) |
| | M | BaC₂O₄, ZrO₂ | NaOH/KOH | 520 | 100 | 70 | 170 | 100 | BaZrO₃ (29%; |
| | | | | | | | | | ~211 nm, 90% |
| | | | | | | | | | cubes/10% |
| | | | | | | | | | spheres) with |
| | | | | | | | | | BaCO₃ and ZrO₂. |
| | N | BaC₂O₄, ZrO₂ | NaOH/KOH | 520 | 100 | 100 | 200 | 100 | BaZrO₃ (45%; |
| | | | | | | | | | ~222 nm; 85% |
| | | | | | | | | | cubes/15% |
| | | | | | | | | | spheres) with |
| | | | | | | | | | BaCO₃ and ZrO₂. |
| | O | BaC₂O₄, ZrO₂ | NaOH/KOH | 520 | 100 | 160 | 260 | 100 | BaZrO₃ (67%; |
| | | | | | | | | | ~297 nm; 75% |
| | | | | | | | | | cubes/25% |
| | | | | | | | | | spheres) with |
| | | | | | | | | | BaCO₃ and ZrO₂. |
| | G | BaC₂O₄, ZrO₂ | NaOH/KOH | 520 | 100 | 250 | 350 | 100 | BaZrO₃ (84%; |
| | | | | | | | | | ~422 nm; 50% |
| | | | | | | | | | cubes/50% |
| | | | | | | | | | spheres) with |
| | | | | | | | | | BaCO₃ and ZrO₂. |
| Influence | G | BaC₂O₄, ZrO₂ | NaOH/KOH | 520 | 100 | 250 | 350 | 100 | BaZrO₃ (84%; |
| of Cooling | | | | | | | | | ~422 nm; 50% |
| Rate | | | | | | | | | cubes/50% |
| | | | | | | | | | spheres) with |
| | | | | | | | | | BaCO₃ and ZrO₂. |
| | P | BaC₂O₄, ZrO₂ | NaOH/KOH | 520 | 100 | 250 | 350 | 3.5 | BaZrO₃ (100%; |
| | | | | | | | | | ~450 nm; 40% |
| | | | | | | | | | cubes/60% |
| | | | | | | | | | spheres) |
| | J | BaC₂O₄, ZrO₂ | NaOH/KOH | 720 | 140 | 30 | 170 | 100 | BaZrO₃ (100%; |
| | | | | | | | | | ~120 nm; 100% |
| | | | | | | | | | cubes) |
| | Q | BaC₂O₄, ZrO₂ | NaOH/KOH | 720 | 140 | 30 | 170 | 3.5 | BaZrO₃ (100%; |
| | | | | | | | | | ~200 nm; 50% |
| | | | | | | | | | cubes/50% |
| | | | | | | | | | spheres) |
| | L | BaC₂O₄, ZrO₂ | NaOH/KOH | 720 | 140 | 120 | 260 | 100 | BaZrO₃ (100%; |
| | | | | | | | | | ~265 nm; 30% |
| | | | | | | | | | cubes/70% |
| | | | | | | | | | spheres) |
| | R | BaC₂O₄, ZrO₂ | NaOH/KOH | 720 | 140 | 120 | 260 | 3.5 | BaZrO₃ (100%; |
| | | | | | | | | | ~300 nm; 100% |
| | | | | | | | | | spheres) |
| | B | BaC₂O_{4,} | NaOH/KOH | 720 | 140 | 210 | 350 | 3.5 | BaZrO₃ (100%; |
| | | ZrO₂ | | | | | | | ~320 nm; 100% |
| | | | | | | | | | spheres) |
| Nature of | S | BaO, ZrO₂ | NaOH/KOH | 720 | 140 | 210 | 350 | 3.5 | BaZrO₃ (100%; |
| Precursor | | | | | | | | | ~490 nm; 100% |
| | | | | | | | | | spheres) |
| | T | BaCO₃, | NaOH/KOH | 720 | 140 | 210 | 350 | 3.5 | BaZrO₃ (100%; |
| | | ZrO₂ | | | | | | | ~340 nm; 100% |
| | | | | | | | | | spheres) |
| | U | BaCl₂, | NaOH/KOH | 720 | 140 | 210 | 350 | 3.5 | BaZrO₃ (67%; |
| | | ZrO₂ | | | | | | | aggregates) with |
| | | | | | | | | | BaCO₃ and ZrO₂. |
| | V | Ba(NO₃)₂, | NaOH/KOH | 720 | 140 | 210 | 350 | 3.5 | BaZrO₃ (71%; |
| | | ZrO₂ | | | | | | | aggregates) with |
| | | | | | | | | | BaCO₃ and ZrO₂. |
| | W | Ba | NaOH/KOH | 720 | 140 | 210 | 350 | 3.5 | BaZrO₃ (75%; |
| | | (OOCCH₃)₂ | | | | | | | ~300 nm; 100% |
| | | ZrO₂ | | | | | | | spheres) with |
| | | | | | | | | | BaCO₃ and ZrO₂. |
| | X | BaC₂O₄, | NaOH/KOH | 720 | 140 | 210 | 350 | 3.5 | BaZrO₃ (76%; |
| | | ZrOCl₂•8H₂O | | | | | | | aggregates) with |
| | | | | | | | | | BaCO₃ and ZrO₂ |

TABLE 2
Table 2. Gibbs' free energy of formation values for reactions 1 and 2
regarding BaZrO₃ particle formation.

| | Reaction 1 | Reaction 2 |
|---|---|---|
| Annealing | (presence of hydroxide ion | (absence of hydroxide ion in |
| Temperature | in molten salt media) | molten salt media) |
| 520° C. | −263 kJ/mol | −153 kJ/mol |
| 620° C. | −320 kJ/mol | −214 kJ/mol |
| 720° C. | −379 kJ/mol | −277 kJ/mol |
| 820° C. | −439 kJ/mol | −341 kJ/mol |

TABLE 3
Table 3. Samples corresponding to sequential growth stages of Sample I (ultimately
annealed at 720° C. for 210 min at a constant heating rate of 5° C. min⁻¹).
For all samples, precursors used included BaC₂O₄ and ZrO₂ in
the presence of a NaOH/KOH salt medium. The cooling rate was
kept constant throughout at ~100°/min.

| | | Time | Time sample | | | | |
|---|---|---|---|---|---|---|---|
| | | required to | was | | | | |
| | | reach | maintained at | Overall | | | Weight |
| | Annealing | desired | desired | reaction | Avg. | Percentage | Percentage |
| | temp. | annealing | annealing | time/ | particle | of spheres | of BaZrO₃ |
| Sample | (° C.) | temp./min | temp./min | min | size (nm) | (%) | (%) |
| 1 | 220 | 40 | 0 | 40 | | 0 | ~0 |
| 2 | 270 | 50 | 0 | 50 | 90 | 0 | ~21.7 |
| 3 | 320 | 60 | 0 | 60 | 91 | 0 | ~38.4 |
| 4 | 420 | 80 | 0 | 80 | 93 | 0 | ~68.8 |
| 5 | 520 | 100 | 0 | 100 | 95 | 0 | ~82.9 |
| 6 | 620 | 120 | 0 | 120 | 98 | 0 | ~87.9 |
| 7 | 720 | 140 | 0 | 140 | 100 | 0 | ~96.1 |
| 8 | 720 | 140 | 30 | 170 | 120 | 0 | ~100 |
| 9 | 720 | 140 | 60 | 200 | 160 | 20 | ~100 |
| 10 | 720 | 140 | 120 | 260 | 265 | 70 | ~100 |
| 11 | 720 | 140 | 210 | 350 | 320 | 95 | ~100 |

1. A method of making a plurality of nanoparticles comprising single crystalline spherical BaZrO₃ particles, cubic BaZrO₃ particles or a mixture of both, the method comprising:
(a) providing a mixture of a barium precursor, a zirconium precursor and a hydroxide salt or hydroxide salts;
(b) heating the mixture to an isothermic annealing temperature, wherein the annealing temperature is in a range of from about 470° C. to about 800° C.;
(c) annealing the mixture at the isothermic annealing temperature for an annealing time of in a range of about 15 minutes to about 280 minutes; and
(d) cooling the mixture at a fixed cooling rate to form the plurality of nanoparticles, wherein the cooling rate is in a range of from about 2° C./minute to about 200° C./minute,
wherein the ratio of spherical particles to cubic particles in the plurality is greater if the isothermic annealing temperature is at the higher end of the range, wherein the ratio of spherical particles to cubic particles in the plurality is greater if the annealing time is at the higher end of the range, and wherein the ratio of spherical particles to cubic particles in the plurality is greater if the cooling rate is at the lower end of the range.

2. The method of claim 1 wherein the plurality comprises about 50% single crystalline spherical BaZrO₃ particles, and about 50% cubic BaZrO₃ particles, wherein the isothermic annealing temperature is in a range of about 500° C. to about 540° C.; wherein the annealing time is in a range of about 240 minutes to about 260 minutes; and wherein the fixed cooling rate is in a range of about 90° C./minute to about 110° C./minute.

3. (canceled)

4. The method of claim 1 wherein the plurality comprises about 65% single crystalline spherical BaZrO₃ particles, and about 35% cubic BaZrO₃ particles, wherein the isothermic annealing temperature is in a range of about 570° C. to about 670° C.; wherein the annealing time is in a range of about 220 minutes to about 240 minutes; and wherein the fixed cooling rate is in a range of about 90° C./minute to about 110° C./minute.

5. (canceled)

6. The method of claim 1 wherein the plurality comprises about 95% single crystalline spherical BaZrO₃ particles, and about 5% cubic BaZrO₃ particles, wherein the isothermic annealing temperature is in a range of about 700° C. to about 740° C.; wherein the annealing time is in a range of about 180 minutes to about 210 minutes; and wherein the fixed cooling rate is in a range of about 90° C./minute to about 110° C./minute.

7. (canceled)

8. The method of claim 1 wherein the plurality comprises about 100% cubic BaZrO₃ particles, wherein the isothermic annealing temperature is in a range of about 670° C. to about 620° C.; wherein the annealing time is in a range of about 10 minutes to about 40 minutes; and wherein the fixed cooling rate is in a range of about 90° C./minute to about 110° C./minute.

9. (canceled)

10. The method of claim 1 wherein the plurality comprises about 20% single crystalline spherical BaZrO₃ particles, and about 80% cubic BaZrO₃ particles, wherein the isothermic annealing temperature is about 700° C. to about 740° C.; wherein the annealing time is in a range of about 40 minutes to about 90 minutes; and wherein the fixed cooling rate is in a range of about 90° C./minute to about 110° C./minute.

11. (canceled)

12. The method of claim 1 wherein the plurality comprises about 70% single crystalline spherical BaZrO₃ particles, and about 30% cubic BaZrO₃ particles, wherein the isothermic annealing temperature is in a range of about 700° C. to about 740° C.; wherein the annealing time is in a range of about 100 minutes to about 140 minutes; and wherein the fixed cooling rate is in a range of about 90° C./minute to about 110° C./minute.

13. (canceled)

14. The method of claim 1 wherein the plurality comprises about 10% single crystalline spherical BaZrO₃ particles, and about 90% cubic BaZrO₃ particles, wherein the isothermic annealing temperature is in a range of about 500° C. to about 540° C.; wherein the annealing time is in a range of about 50 minutes to about 90 minutes; and wherein the fixed cooling rate is in a range of about 90° C./minute to about 110° C./minute.

15. (canceled)

16. The method of claim 1 wherein the plurality comprises about 15% single crystalline spherical BaZrO₃ particles, and about 85% cubic BaZrO₃ particles, wherein the isothermic annealing temperature is in a range of about 500° C. to about 540° C.; wherein the annealing time is in a range of about 90 minutes to about 120 minutes; and wherein the fixed cooling rate is in a range of about 90° C./minute to about 110° C./minute.

17. (canceled)

18. The method of claim 1 wherein the plurality comprises about 25% single crystalline spherical BaZrO₃ particles, and about 75% cubic BaZrO₃ particles, wherein the isothermic annealing temperature is in a range of about 500° C. to about 540° C.; wherein the annealing time is in a range of about 160 minutes to about 190 minutes; and wherein the fixed cooling rate is in a range of about 90° C./minute to about 110° C./minute.

19. (canceled)

20. The method of claim 1 wherein the plurality comprises about 60% single crystalline spherical BaZrO₃ particles, and about 40% cubic BaZrO₃ particles, wherein the isothermic annealing temperature is in a range of about 500° C. to about 540° C.; wherein the annealing time is in a range of about 220 minutes to about 280 minutes; and wherein the fixed cooling rate is in a range of about 2° C./minute to about 20° C./minute.

21. (canceled)

22. The method of claim 1 wherein the plurality comprises about 50% single crystalline spherical BaZrO₃ particles, and about 50% cubic BaZrO₃ particles, wherein the isothermic annealing temperature is in a range of about 700° C. to about 740° C.; wherein the annealing time is in a range of about 10 minutes to about 40 minutes; and wherein the fixed cooling rate is in a range of about 2° C./minute to about 20° C./minute.

23. (canceled)

24. The method of claim 1 wherein the plurality comprises about 100% single crystalline spherical BaZrO₃ particles, wherein the isothermic annealing temperature is in a range of about 700° C. to about 740° C.; wherein the annealing time is in a range of about 110 minutes to about 130 minutes; and wherein the fixed cooling rate is in a range of about 2° C./minute to about 20° C./minute.

25. (canceled)

26. The method of claim 1 wherein the mixture does not include a surfactant and/or nitric salt.

27-32. (canceled)

33. A method of making a plurality of single crystalline spherical BaZrO₃ particles, the method comprising:
(a) providing a mixture of a barium precursor, a zirconium precursor and a hydroxide salt or hydroxide salts;
(b) heating the mixture to an isothermic annealing temperature, wherein the annealing temperature is in a range of from about 700° C. to about 800° C.;
(c) annealing the mixture at the isothermic annealing temperature for an annealing time of in a range of about 100 minutes to about 280 minutes; and
(d) cooling the mixture at a fixed cooling rate to form a plurality of single crystalline spherical BaZrO₃ particles, wherein the cooling rate is in a range of from about 2° C./minute to about 20° C./minute
wherein the size of the spherical particles is larger when the isothermic annealing temperature is at the higher end of the range, wherein the size of spherical particles is larger when the annealing time is at the higher end of the range, and wherein the size of the spherical particles is larger when the cooling rate is in the lower end of the range.

34. The method of claim 33 wherein the mixture does not include a surfactant and/or nitric salt.

35-44. (canceled)

45. A method of making a plurality of single crystalline cubic BaZrO₃ particles, the method comprising:
(a) providing a mixture of a barium precursor, a zirconium precursor and a chloride salt or chloride salts;
(b) heating the mixture to an isothermic annealing temperature, wherein the annealing temperature is in a range of from about 500° C. to about 900° C.;
(c) annealing the mixture at the isothermic annealing temperature for an annealing time in a range of about 15 minutes to about 250 minutes;
(d) cooling the mixture at a fixed cooling rate to form a plurality of single crystalline cubic BaZrO₃ particles, wherein the cooling rate is in a range of from about 2° C./minute to about 200° C./minute,
wherein the size of the cubic particles is larger when the isothermic annealing temperature is at the higher end of the range, wherein the size of the cubic particles is larger when the annealing time is greater, and wherein the size of the cubic articles is larger when the cooling rate is at the lower end of the range.

46. The method of claim 45 wherein the mixture does not include a surfactant and/or nitric salt.

47-52. (canceled)

53. A method of controlling the morphology of a plurality of produced nanoparticles, the method comprising:
(a) providing a mixture of a barium precursor, a zirconium precursor and salt;
(b) heating the mixture to an isothermic annealing temperature, wherein the annealing temperature is in a range of from about 500° C. to about 900° C., or 600° C. to about 800° C.;
(c) annealing the mixture at the isothermic annealing temperature for an annealing time in a range of about 15 minutes to about 280 minutes; and
(d) cooling the mixture at a fixed cooling rate to produce a plurality of nanoparticles, wherein the cooling rate is in a range of from about 2° C./minute to about 200° C./minute,
wherein the ratio of spherical particles to cubic particles in the plurality is greater if the salt is a hydroxide salt,
wherein the plurality consists essentially of cubic particles if the salt is a chloride salt,
wherein the ratio of spherical particles to cubic particles in the plurality is greater if the isothermic annealing temperature is at the higher end of the range,
wherein the ratio of spherical particles to cubic particles in the plurality is greater if the annealing time is at the higher end of the range, and
wherein the ratio of spherical particles to cubic particles in the plurality is greater if the cooling rate is at the lower end of the range.

54-60. (canceled)

61. A method of controlling the morphology of a plurality of produced nanoparticles, the method comprising:
(a) providing a mixture of a barium precursor, a zirconium precursor and salt;
(b) heating the mixture to an isothermic annealing temperature, wherein the annealing temperature is in a range of from about 500° C. to about 900° C., or 600° C. to about 800° C.;
(c) annealing the mixture at the isothermic annealing temperature for an annealing time in a range of about 15 minutes to about 280 minutes; and
(d) cooling the mixture at a fixed cooling rate to produce a plurality of nanoparticles, wherein the cooling rate is in a range of from about 2° C./minute to about 200° C./minute,
wherein the ratio of spherical particles to cubic particles in the plurality is greater if the salt is a hydroxide salt,
wherein the plurality consists essentially of cubic particles if the salt is a halogenated salt,
wherein the ratio of spherical particles to cubic particles in the plurality is greater if the isothermic annealing temperature is at the higher end of the range,
wherein the ratio of spherical particles to cubic particles in the plurality is greater if the annealing time is at the higher end of the range, and
wherein the ratio of spherical particles to cubic particles in the plurality is greater if the cooling rate is at the lower end of the range.
